(19) United States
(12) Patent Application Publication
(10) Pub. No.: US 2012/0208448 A1
(43) Pub. Date: Aug. 16, 2012

(54) INFORMATION DISTRIBUTION SYSTEM, INFORMATION DISTRIBUTION MANAGEMENT DEVICE, INFORMATION DISTRIBUTION MANAGEMENT METHOD, INFORMATION DISTRIBUTION MANAGEMENT PROGRAM, INFORMATION RECEPTION DEVICE, INFORMATION RECEPTION METHOD AND, INFORMATION RECEPTION PROGRAM

(75) Inventor: Soju GOTO, Yokohama-shi (JP)

(73) Assignee: JVC KENWOOD CORPORATION, Yokohama-shi (JP)

(21) Appl. No.: 13/457,596

(22) Filed: Apr. 27, 2012

Related U.S. Application Data
(63) Continuation of application No. PCT/JP2010/002255, filed on Mar. 29, 2010.

(30) Foreign Application Priority Data
Oct. 30, 2009 (JP) 2009-249680
Oct. 30, 2009 (JP) 2009-249688

(51) Int. Cl. H04W 4/06

(52) U.S. Cl. 455/3.01

(57) ABSTRACT

A content output propriety determination unit determines whether an output of the content is allowed in an information reception device based on reception statuses of radio waves from a plurality of radio stations in the information reception device and position information on the information reception device. A communication controller transmits a determination result by the content output propriety determination unit to the information reception device. A table creation unit creates a radio wave status acquisition table based on the position information on the information reception device, and the radio wave status acquisition table is used for acquiring the reception statuses of the radio waves from the radio stations. When some radio stations are receivable, the content output propriety determination unit allows output of contents distributed from the information distribution devices corresponding to all the radio stations included in the table.

### CROSS REFERENCE TO RELATED APPLICATIONS

This application is a continuation application of International application No. PCT/JP2010/002255, filed on Mar. 29, 2010, entitled “INFORMATION DISTRIBUTION SYSTEM, INFORMATION DISTRIBUTION MANAGEMENT DEVICE, INFORMATION DISTRIBUTION MANAGEMENT METHOD, INFORMATION DISTRIBUTION MANAGEMENT PROGRAM, INFORMATION RECEPTION DEVICE, INFORMATION RECEPTION METHOD AND, INFORMATION RECEPTION PROGRAM”, which claims priority based on Article 8 of the Patent Cooperation Treaty from Japanese Patent Applications No. 2009-249688 and No. 2009-249680 filed on Oct. 30, 2009, entitled “INFORMATION DISTRIBUTION SYSTEM, INFORMATION DISTRIBUTION MANAGEMENT DEVICE, INFORMATION DISTRIBUTION MANAGEMENT METHOD, INFORMATION DISTRIBUTION MANAGEMENT PROGRAM, INFORMATION RECEPTION DEVICE, INFORMATION RECEPTION METHOD AND, INFORMATION RECEPTION PROGRAM”, the entire contents of which are incorporated herein by reference.

### BACKGROUND OF THE INVENTION

1. Field of the Invention

The invention relates to an information distribution system, an information distribution management device, an information distribution management method, an information distribution management program, an information reception device, an information reception method, and an information reception program.

2. Description of the Related Art

When broadcast contents provided by a broadcast station through terrestrial digital broadcasting are redistributed via an IP (Internet Protocol) communication network, a service area of the broadcast contents needs to be limited to a broadcast range of the broadcast station to avoid potential problems under applicable Radio Law or Copyright Law. An exemplar known method for limiting a service area includes: comparing area information stored in a reception device capable of receiving broadcast contents via an IP communication network with area information obtained from personal information on a user of the receiving device, the personal information being registered with an Internet service provider to which the user subscribes for Internet connection; determining whether an area where the reception device is installed is an area allowed to receive broadcast contents from a broadcast station; and based on the determination, limiting a range for providing the broadcast content via the IP communication network to the broadcast range of the broadcast station (for example, refer to Japanese Patent Application Publication No. 2007-329783).

However, the method disclosed in Japanese Patent Application Publication No. 2007-329783 requires a request to the Internet service provider, to which the user of the reception device subscribes for Internet connection, to disclose the personal information registered with the Internet service provider. Accordingly, the Internet service provider is forced to manage personal information by using different personal information management methods between the users of receiving devices and users not using receiving devices. This may complicate the personal information management by the Internet service provider. Further, if the Internet service provider does not agree to the request to disclose part of the personal information on the user for the above-described or other purpose, only some of Internet service providers are available for the receiving device. As a result, a user who desires to use a redistribution service of broadcast contents with the reception device cannot freely select an Internet service provider to subscribe with for an Internet connection.

### SUMMARY OF THE INVENTION

One aspect of the present invention is an information distribution system including: an information reception device configured to receive information that a radio station sends via radio waves; an information distribution device configured to distribute information to the information reception device; and an information distribution management device configured to manage the information distribution. Within a content delivery range where the radio station sends a content via the radio waves, the information distribution device distributes the content via a communication medium different from the radio waves. The information distribution management device includes: a content output propriety determination unit configured to determine whether or not output of the content is allowed in the information reception device based on reception statuses of radio waves from a plurality of radio stations in the information reception device and position information on the information reception device; a communication controller configured to transmit a determination result by the content output propriety determination unit to the information reception device; and a table creation unit configured to create a radio wave status acquisition table based on the position information on the information reception device. The radio wave status acquisition table is used for acquiring the reception statuses of the radio waves from the radio stations. The content output propriety determination unit transmits the radio wave status acquisition table created by the table creation unit to the information reception device. A determination that some radio stations are receivable is made based on the reception statuses of radio waves from some radio stations out of the reception statuses of the radio waves from the radio stations acquired based on the radio wave status acquisition table and transmitted from the information reception device. When this determination is made that the some radio stations are receivable, the content output propriety determination unit allows output of contents distributed from the information distribution devices corresponding to all the radio stations included in the table.

The information reception device includes: a communication unit capable of communicating with an information distribution device capable of distributing a content within the content delivery range of the radio station by using the communication medium different from the radio waves; a content output propriety determination information output unit configured to send its own position information to the information distribution management device capable of determining whether or not output of the content distributed from the information distribution device to the information reception device via the communication unit is allowed in the information reception device, and to receive the radio wave status acquisition table created based on the position information by the information distribution management device and used for acquiring the reception statuses of the radio waves from the radio stations, and to acquire the reception statuses of the radio waves from the radio stations included in the radio wave status acquisition table, and to transmit the acquired radio wave statuses to the information distribution management device; and a content output controller configured to determine whether or not output of the content distributed from the information distribution device is allowed based on the content output propriety determination result transmitted from the information distribution management device.

Another aspect of the invention provides an information distribution system that comprises: an information reception device configured to receive information sent via radio waves from a radio station; an information distribution device configured to distribute information to the information reception device; and an information distribution management device configured to manage information distribution, wherein the information distribution device is further configured to distribute a content via a communication medium different from the radio waves within a content delivery range within which the radio station sends the content via radio waves, wherein the information distribution management device comprises: a table creation unit configured to create a radio wave status acquisition table for the information reception device for acquiring reception statuses of the radio waves from radio stations based on position information on the information reception device; and a communication controller configured to send the information reception device the radio wave status acquisition table, wherein the information reception device comprises: a reception device configured to receive the content distributed from the information distribution device; a content output propriety determination unit configured to determine whether output of contents receivable by the reception device are allowed based on the reception statuses of the radio waves from the radio stations and the content output propriety determination unit's own position information; and a communication controller configured to make a content distribution request to the information distribution device based on a determination result by the content output propriety determination unit, wherein the communication controller is configured to communicate with the information distribution management device, wherein the content output propriety determination unit is configured to send its own position information to the information distribution management device via the communication controller, to receive the radio wave status acquisition table created based on the position information, and to allow output of contents distributed from the information distribution devices corresponding to all the radio stations included in the table when determining that some of the radio stations included in the radio wave status acquisition table are receivable based on the reception statuses of radio waves from the some radio stations.

Still another aspect of the invention provides a An information distribution management device capable of determining whether an output of a content is allowed, which comprises: a content output propriety determination unit configured to determine whether an output of a content provided by an information distribution device is allowed in an information reception device based on reception statuses in the information reception device of radio waves from a plurality of radio stations and position information on the information reception device, wherein the information reception device is configured to receive a content that a radio station sends via radio waves, and the information distribution device is configured to distribute the content within a content delivery range of the radio station via a communication medium other than the radio waves; a communication controller configured to transmit a determination result by the content output propriety determination unit to the information reception device; and a table creation unit configured to create a radio wave status acquisition table used for acquiring the reception statuses of the radio waves from the radio stations based on the position information on the information reception device, wherein the content output propriety determination unit is configured to send the information reception device the radio wave status acquisition table, to determine whether output of contents from the information distribution devices corresponding to the some radio stations is allowed in the information reception device based on the reception statuses of the radio waves from some radio stations out of the reception statuses of the radio waves from the radio stations acquired based on the radio wave status acquisition table and transmitted from the information reception device, and, when it is determined that the output of the contents from the information distribution devices corresponding to the some radio stations is allowed, to allow output of the contents distributed from the information distribution devices corresponding to all the radio stations included in the table.

Still another aspect of the invention provides an information distribution management method that comprises: determining as a determination result whether output of a content distributed to an information reception device from an information distribution device is allowed in the information reception device based on a communication status of a first communication medium in the information reception device and position information on the information reception device, the information reception device being capable of receiving the content that a radio station sends via the first communication medium, and the information distribution device being capable of distributing the content within a content delivery range of the first communication medium via a second communication medium different from the first communication; transmitting the determination result to the information reception device; creating a reception status acquisition table including radio stations associated with the position information on the information reception device; transmitting the created reception status acquisition table to the information reception device; receiving, from the information reception device, reception statuses of associated radio stations via the first communication medium acquired based on the reception status acquisition table; determining whether an output of contents from the information distribution devices corresponding to some of the associated radio stations is allowed in the information reception device, based on the reception statuses of the some of the associated radio stations; and allowing output of the contents distributed from the information distribution devices corresponding to all the radio stations included in the reception status acquisition table when the step of determining shows that the output of the contents from the information distribution devices corresponding to the some radio stations is allowed.

Still another aspect of the invention provides a computer program product comprising program instructions recorded on a computer readable medium, wherein upon execution on a computer, said program instructions decide whether to output contents to a receiving device, the program instructions comprises: determining as a determination result whether output of a content distributed to an information reception device from an information distribution device is allowed in the information reception device based on a communication status of a first communication medium in the information reception device and position information on the information reception device, wherein the information reception device is configured to receive the content that a radio station sends via the first communication medium, and the information distribution device is configured to distribute the content within a content delivery range of the first communication medium via a second communication medium different from the first communication; transmitting the determination result to the information reception device; creating a reception status acquisition table including radio stations associated with the position information on the information reception device; transmitting the created reception status acquisition table to the information reception device; receiving, from the information reception device, reception statuses from the associated radio stations via the first communication medium acquired based on the reception status acquisition table; determining whether or not output of contents from the information distribution devices corresponding to some of the associated radio stations is allowed in the information reception device, based on the reception statuses of the some radio stations; and when determining that the output of the contents from the information distribution devices corresponding to the some radio stations is allowed in the information reception device, allowing output of the contents distributed from the information distribution devices corresponding to all the radio stations included in the reception status acquisition table.

Still another aspect of the invention provides an information reception device, which comprises: a reception unit configured to receive a content distributed from an information distribution device that distributes the content within a content delivery range where a radio station sends the content via radio waves, and distributes the content via a communication medium different from the radio waves; a content output propriety determination unit configured to determine as a determination result whether an output is allowed of the content capable of being received from the reception unit, said determination result being based on reception statuses of radio waves from a plurality of radio stations in the information reception device and position information on the information reception device; and a communication controller configured to make a content distribution request to the information distribution device based on the determination result by the content output propriety determination unit, wherein the communication controller is capable of communicating with an information distribution management device having a radio wave status acquisition table used for acquiring the reception statuses of radio waves of the radio stations, wherein the content output propriety determination unit is configured to send its own position information to the information distribution management device via the communication controller, to receive the radio wave status acquisition table created based on the position information, and when some radio stations included in the radio wave status acquisition table are determined to be receivable based on the reception statuses of radio waves from the some radio stations, to allow output of contents distributed from the information distribution devices corresponding to all radio stations included in the table.

Still another aspect of the invention provides an information reception method usable with an information reception device configured to receive content that a radio station sends via a first communication medium, and an information distribution device configured to distribute the content within a content delivery range of the first communication medium via a second communication medium different from the first communication medium. said method comprises the steps of: Sending position information of reception to the information distribution device; receiving a created reception status acquisition table from the information distribution management device; detecting reception statuses from associated radio stations based on the reception status acquisition table; determining whether an output of contents is allowed, based on the reception statuses transmitting via the first communication medium and the position information of the reception device; and requesting the content distribution corresponding to all radio stations included in the reception status acquisition table based on a determination that at least one of the associated radio stations is receivable.

Still another aspect of the invention provides a computer program product comprising program instructions recorded on a computer readable medium for activation of apparatus that includes an information reception device configured to receive a content that a radio station sends via a first communication medium, and an information distribution device configured to distribute the content within a content delivery range of the first communication medium via a second communication medium different from the first communication medium, wherein upon execution on a computer, said program instructions decide whether to receive contents. The program instructions comprise instruction for: sending position information of reception to the information distribution device; receiving a created reception status acquisition table of associated radio stations from an information distribution management device; detecting reception statuses of the associated radio stations based on the reception status acquisition table;

determining whether an output of contents is allowed, based on the reception statuses transmitting via the first communication medium and the position information of the information reception device; and requesting a contents distribution corresponding to all radio stations included in the reception status acquisition table based on a determination that at least one of the associated radio stations is receivable.

According to above, it is possible to provide an information distribution system, an information distribution management device, an information distribution management method, an information distribution management program, an information reception device, an information reception method, and an information reception program capable of distributing a content, distributed via a certain communication medium, via another communication medium by transmitting/receiving the content appropriately without excessive use of personal information.

### BRIEF DESCRIPTION OF THE DRAWINGS

FIG. 1 is a block diagram illustrating an exemplary entire configuration of an information distribution system according to a first embodiment;

FIG. 2 is a block diagram illustrating an exemplary entire configuration of a broadcast station shown in FIG. 1;

FIG. 3 is a block diagram illustrating an exemplary entire configuration of a broadcast station portal server shown in FIG. 1;

FIG. 4 is a view illustrating an example of data stored in a broadcast station information DB shown in FIG. 3;

FIG. 5 is a view illustrating an example of data stored in a tuner IC DB shown in FIG. 3;

FIG. 6 is a block diagram illustrating an exemplary entire configuration of a broadcast station management server shown in FIG. 1;

FIG. 7 is a view illustrating an example of information stored in position information conversion DB shown in FIG. 6;

FIG. 8 is a block diagram illustrating an exemplary entire configuration of a reception device shown in FIG. 1;

FIG. 9 is a flowchart of an area identification process executed between the reception device and the broadcast station management server shown in FIG. 1;

FIG. 10 is a flowchart of an output propriety determination process executed between the reception device and the broadcast station management server shown in FIG. 1;

FIG. 11 is a flowchart of a content distribution process executed between the reception device and the broadcast station portal server shown in FIG. 1;

FIG. 12 is a view illustrating another example of information stored in the position information conversion DB shown in FIG. 6;

FIG. 13 is a block diagram illustrating an exemplary entire configuration of a broadcast station management server in an information distribution system according to a second embodiment;

FIG. 14 is a block diagram illustrating an exemplary entire configuration of a reception device in the information distribution system according to the second embodiment; and

FIG. 15 is a flowchart of an output propriety determination process executed between the reception device and the broadcast station management server in the information distribution system according to the second embodiment.

### DETAILED DESCRIPTION OF THE EMBODIMENTS

Embodiments of the invention are described with reference to the drawings. Further, the invention is not limited to the following embodiments.

### First Embodiment

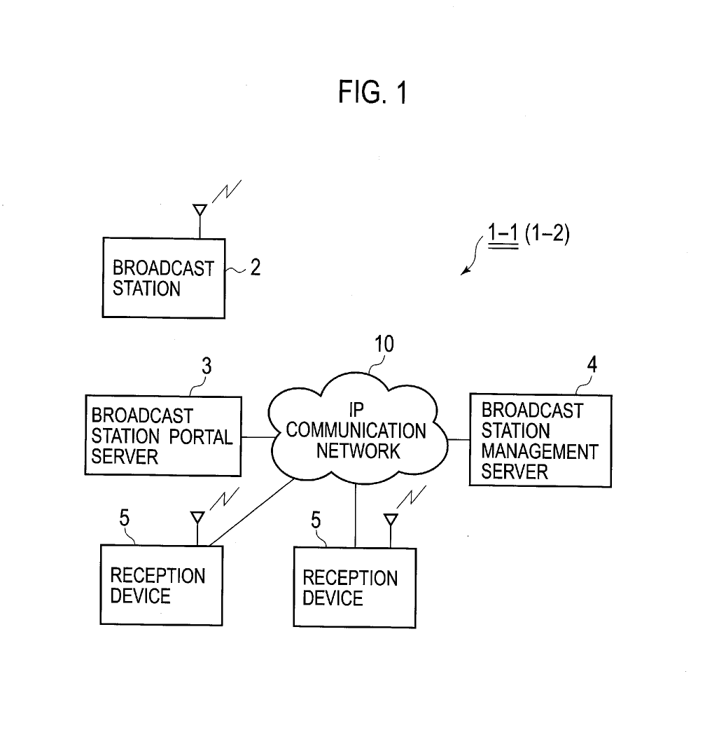

Firstly, information distribution system 1-1 according to a first embodiment is described. FIG. 1 is a block diagram illustrating an entire configuration of information distribution system 1-1 according to the first embodiment. As shown in FIG. 1, information distribution system 1-1 is configured to include broadcast station 2, broadcast station portal server 3, broadcast station management server 4, and receiving devices 5. In information distribution system 1-1, a broadcast content can be received such that reception device 5 receives broadcast waves sent from an antenna of broadcast station 2. Further, reception device 5 can receive, via IP communication network 10, a broadcast content that broadcast station 2 described above provides from broadcast station portal server 3 and/or contents other than the broadcast content. Although one broadcast station 2, one broadcast station portal server 3 corresponding to concerned broadcast station 2, one broadcast station management server 4, and two receiving devices 5 are illustrated in information distribution system 1-1 shown in FIG. 1 as an example, alternatively, information distribution system 1-1 may be configured to include multiple broadcast stations 2, multiple broadcast station portal servers 3, multiple broadcast station management servers 4, and three or more receiving devices 5 for a unit of a state, a unit of a county, a city, a district, or the like. Further, although one broadcast station portal server 3 corresponding to one broadcast station 2 is present in information distribution system 1-1 shown in FIG. 1 as the example, multiple broadcast station portal servers 3 corresponding to one broadcast station 2 may be present, or broadcast station 2 having no broadcast station portal server 3 may be included.

Reception device 5 in information distribution system 1-1 performs: (1) a process of authenticating correctness as a device of concerned reception device 5 with broadcast station management server 4 via IP communication network 10, (2) a process of identifying an area where concerned reception device 5 is installed, and (3) a process of determining whether output of a content provided from each broadcast station portal server 3 is allowed in the area where concerned reception device 5 is installed. After executing these processes, reception device 5 performs a content distribution request to broadcast station portal server 3. IP communication network 10 is a communication network for performing communication between broadcast station portal server 3 and reception device 5. IP communication network 10 may be, for example, the Internet that uses a communication protocol such as TCP/IP, or a network which is any one of CATV, dedicated line, VPN (virtual LAN), WAN or a combination thereof. Further, IP communication network 10 may include a network that uses a different communication protocol other than the IP communication.

(Broadcast Station) Broadcast station 2 sends a broadcast program content as stream data in accordance with a broadcast schedule. Further, broadcast station 2 can send data broadcast and EPG (Electronic Program Guide) information, by being superimposed on broadcast waves, respectively. Note that, broadcast station 2 is an example of a radio station.

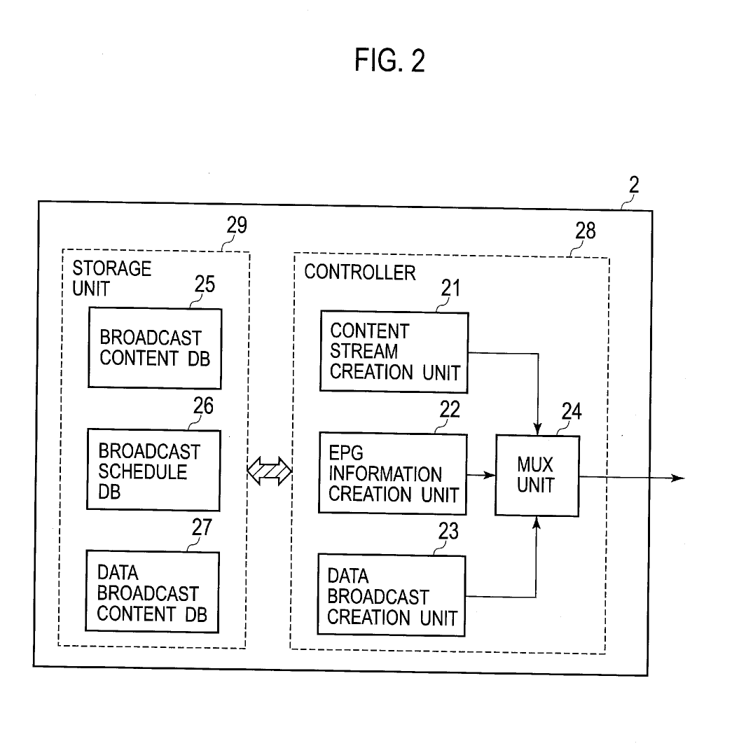

FIG. 2 is a block diagram illustrating an exemplary entire configuration of broadcast station 2 shown in FIG. 1. As shown in FIG. 2, broadcast station 2 is configured to include content stream creation unit 21, EPG information creation unit 22, data broadcast creation unit 23, MUX (Multiplexer) unit 24, broadcast content DB 25, broadcast schedule DB 26, and data broadcast content DB 27, as main components. Here, information processing implemented by functions of content stream creation unit 21, EPG information creation unit 22, data broadcast creation unit 23, and MUX unit 24, which are described above, is implemented such that controller 28 controlling entire broadcast station 2 executes the processing together with a hardware resource, which is not illustrated. Specifically, the information processing is implemented such that controller 28 includes a CPU serving as the hardware resource, which is not illustrated, and the like, and a central processing device such as the CPU reads out into a RAM, which is not illustrated, various kinds of programs stored in a storage part, which is not illustrated, such as a ROM, a hard disk drive, or a flash memory to execute the programs together with the RAM. Further, storage unit 29 stores therein broadcast content database (DB) 25, broadcast schedule DB 26, and data broadcast content DB 27 which are described above, and a storage device such as a HDD (Hard Disk Drive) or a flash memory serves as concerned storage unit 29.

Content stream creation unit 21 refers to broadcast content DB 25 to create a broadcast content. Further, explanation is made in the embodiment assuming that the broadcast content is coded and multiplexed in conformity with the standard of MPEG2 (Moving Picture Experts Group 2). In the standard of MPEG2, a video, sound, and the like of the content to be transmitted are generated as coded ES (Elementary Stream), and the ES is packetized for each meaningful unit to generate a PES (Packetized Elementary Stream). Broadcast station 2 transmits a TS (Transport Stream) packet obtained by dividing the PES.

Further, each TS packet can be classified into video data, sound data, control data, and the like of the broadcast content by assigning a so-called PID of a 13-bit packet identifier to a header of each TS packet. Further, the control data here indicates data referred to as SI/PSI (Service Information/Program Specific Information). The SI of SI/PSI includes information or the like necessary for creating EPG information, and the PSI thereof is control data including information for performing a basic control. The TS packet may be subjected to encryption processing (hereinafter, referred to as “scramble processing”) in order to prevent viewing against interception of broadcast station 2. Here, Multi2 can be used as a method of scramble processing, for example. This Multi2 is one of the methods for encryption of digital data, and is widely applied to BS (base station) digital broadcasting, terrestrial digital broadcasting, and the like. Further, broadcast content DB 25 stores therein information which is a source of the broadcast content described above.

EPG information creation unit 22 refers to broadcast schedule DB 26 to create EPG information. Although a broadcast schedule of one broadcast station 2 is stored in broadcast schedule DB 26, broadcast schedule information of another broadcast station 2 may be stored therein.

Data broadcast creation unit 23 creates, from data broadcast content DB 27, information relating to the data broadcast, for example, information related to a weather forecast or a program. Further, explanation is made assuming that the information relating to the data broadcast is also coded and multiplexed in conformity with the standard of the MPEG2, similar to the broadcast content described above. Data broadcast content DB 27 may store therein URL (Uniform Resource Locator) information relating to a certain program and provided from broadcast station portal server 3 described later or search query information which can be utilized in a P2P (Peer to Peer) system, in addition to the information relating to the data broadcast, such as the information related to a weather forecast or a program. Further, data broadcast creation unit 23 supplies this information together to MUX unit 24.

MUX unit 24 generates broadcast data by multiplexing the broadcast content that content stream creation unit 21 creates by referring to broadcast content DB 25, the EPG information that EPG information creation unit 22 creates by referring to broadcast schedule DB 26, and the information relating to the data broadcast that data broadcast creation unit 23 creates by referring to data broadcast content DB 27. The broadcast data is sent from the antenna of broadcast station 2 as broadcast waves.

(Broadcast Station Portal Server)

Broadcast station portal server 3 provides a content, corresponding to broadcast station 2, to reception device 5 via IP communication network 10. The content includes: a broadcast content of broadcast station 2 (a content corresponding to a so-called simultaneous broadcasting by broadcast station 2); an associated content related to the content, such as a still image, sound, and a moving image; and a unique content produced uniquely independent from the broadcast content (for example, a website, text information, still image information, and moving image information which are provided from broadcast station portal server 3), and the like. Note that, broadcast station portal server 3 corresponds to an example of an information distribution device.

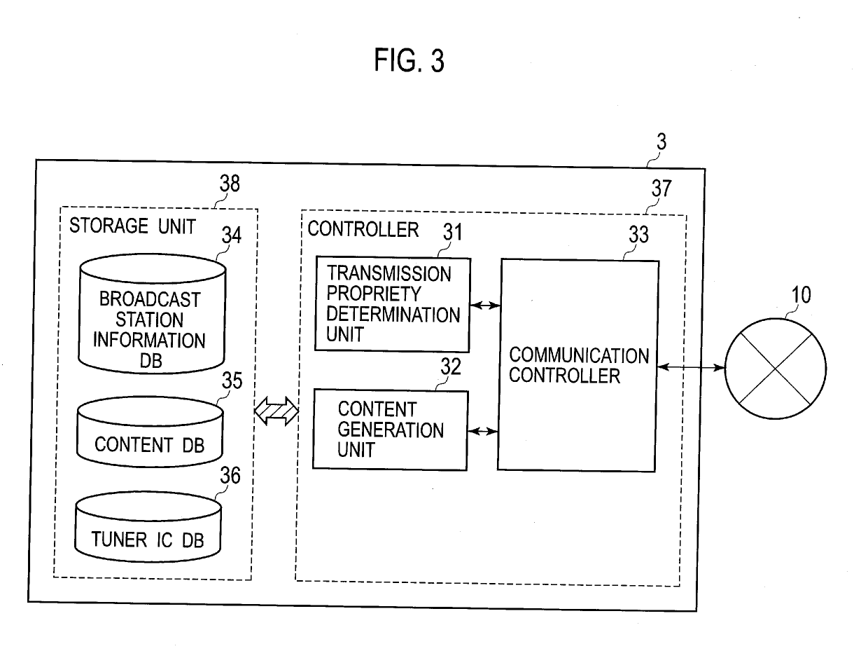

FIG. 3 is a block diagram illustrating an example of broadcast station portal server 3 shown in FIG. 1. As shown in FIG. 3, broadcast station portal server 3 is configured to include transmission propriety determination unit 31, content generation unit 32, and communication controller 33, broadcast station information DB 34, content DB 35, and tuner IC DB 36. Here, information processing implemented by functions of transmission propriety determination unit 31, content generation unit 32, communication controller 33, which are described above, is implemented such that controller 37, controlling the entire broadcast station portal server 3, executes the processing together with a hardware resource, which is not illustrated. Specifically, the information processing is implemented such that controller 37, which includes a CPU serving as the hardware resource, which is not illustrated, and the like, and a central processing device such as the CPU, reads out into a RAM, which is not illustrated, various kinds of programs stored in a storage part, which is not illustrated, such as a ROM, a hard disk drive, or a flash memory to execute the programs together with the RAM. Further, storage unit 38 stores therein broadcast station information DB 34, content DB 35, tuner IC DB 36, which are described above, and a storage device such as a HDD or a flash memory serving as storage unit 38.

Transmission propriety determination unit 31 refers to broadcast station information DB 34 and the like, and determines whether content distribution via IP communication network 10 to reception device 5 requesting content distribution is allowed. Transmission propriety determination unit 31 refers to an output propriety determination result of a radio wave status acquisition table (described later) transmitted from reception device 5 requesting content distribution. When it is determined that the content distribution via IP communication network 10 is not allowed, transmission propriety determination unit 31 notifies concerned reception device 5 that the content cannot be transmitted. On the contrary, when it is determined that the content distribution via IP communication network 10 is allowed by referring to the output propriety determination result of the radio wave status acquisition table transmitted from reception device 5 requesting content distribution, transmission propriety determination unit 31 notifies concerned reception device 5 that the content can be transmitted, and supplies a signal to allow the request for content distribution to content generation unit 32.

Upon receiving the signal to allow the request for content distribution from transmission propriety determination unit 31, content generation unit 32 refers to content DB 35, and generates a content to be transmitted to concerned reception device 5. Here, as for the content to be transmitted to reception device 5, a content requested by reception device 5 may be used, or a content in collaboration with the broadcast program may be generated. When reception device 5 requests a specific content, content generation unit 32 may generate the selected content. In other cases, content generation unit 32 may automatically generate a program collaboration type content to transmit the content. Communication controller 33 is a communication interface that receives a request for content distribution from reception device 5 via IP communication network 10, and transmits the content to reception device 5.

Broadcast station information DB 34 is a database in which information relating to broadcast station 2 is stored. A radio frequency and an area section of concerned broadcast station 2, a reception level condition in the area section, and position information serving as a viewing area that concerned broadcast station portal server 3 can provide a content via IP communication network 10, are stored therein.

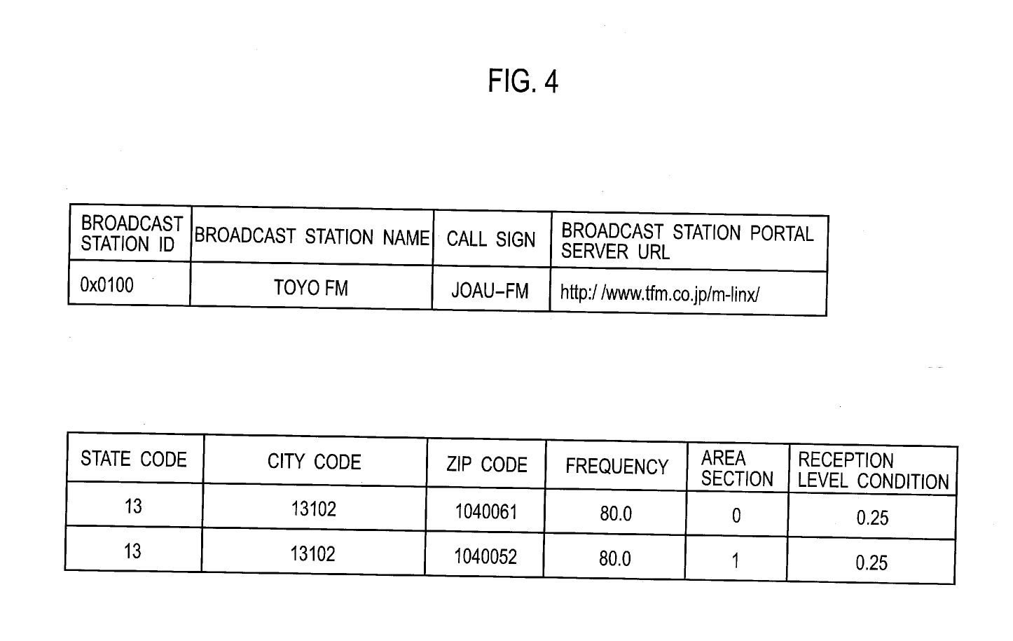

FIG. 4 is a view illustrating an example of data stored in broadcast station information DB 34 shown in FIG. 3. As shown in FIG. 4, the data stored in broadcast station information DB 34 includes a “broadcast station ID”, a “broadcast station name”, a “call sign”, a “broadcast station portal server URL”, and the like, of broadcast station 2, corresponding to concerned broadcast station portal server 3. In the “broadcast station ID”, a code is stored with which broadcast station 2 corresponding to broadcast station portal server 3 can be uniquely identified among multiple broadcast stations 2 in information distribution system 1-1. In the “broadcast station name”, a name is stored of broadcast station 2 corresponding to broadcast station portal server 3. In the “call sign”, an identification number, which is issued based on the International Telecommunication Convention, is stored of broadcast station 2 corresponding to broadcast station portal server 3. In the “broadcast station portal server URL”, a URL such as a website of broadcast station portal server 3 is stored. Accordingly, in broadcast station information DB 34, referring to the “broadcast station ID” allows the “broadcast station name”, the “call sign”, the “broadcast station portal server URL”, and the like, which are in association with the broadcast station ID, to be uniquely determined.

Further, a table, with which viewing area information stored in broadcast station information DB 34 is managed, includes items such as a “state code”, a “city code”, a “zip code”, a “frequency”, an “area section”, and a “reception level condition”. In the “state code”, a number is stored with which a state can be uniquely identified in information distribution system 1-1. In the “city code”, a number is stored with which a county, a city, a district, and the like can be uniquely identified in combination with the “state code” in information distribution system 1-1. In the “zip code”, a zip code of an area is stored which is uniquely identified with the “state code” and the “city code.” In the “frequency”, a frequency of broadcast waves from broadcast station 2 in the area is stored which is uniquely identified with the “state code” and the “city code.” In the “area section”, a flag (1 or 0) is stored indicating an area section for determination of a reception status of the “frequency” of broadcast station 2 in the area which is uniquely identified with the “state code” and the “city code.” A value “0” of the flag indicates a service area (broadcast license area which is an area possibly having a good reception state), while a value “1” thereof indicates a fringe area (area other than the broadcast license area and possibly having a bad reception state). In the “reception level condition”, a numerical value is stored of a reception level condition necessary for reception from broadcast station 2 identified with the “frequency” in the area which is uniquely identified with the “state code” and the “city code.” Further, a unit of the numerical value stored in the “reception level condition” is milli-volts per meter (mV/m).

Accordingly, in broadcast station information DB 34, identification of a “state code” and a “city code” makes it possible to identify a “zip code” in an area which is identified with the codes, and broadcast station 2 in the area is identified with the “frequency”. In this manner, it is possible to identify an “area section” indicating whether broadcast station 2, which is identified with the “frequency”, is a service area or a fringe area in the area, and indicating a “reception level condition” necessary for reception from broadcast station 2 in the area. Alternatively, in broadcast station information DB 34, it is possible to use a “zip code” as a key, and identify broadcast station 2 which is receivable in an area identified with the “zip code” with the “frequency”. Further, it is possible to uniquely identify an “area section” indicating whether broadcast station 2, which is identified with the “frequency”, is a service area or a fringe area in the area, and indicating a “reception level condition” necessary for reception from broadcast station 2 in the area. Further, broadcast station portal server 3 can provide the data stored in broadcast station information DB 34 to broadcast station management server 4 via IP communication network 10.

Content DB 35 is a database in which various contents are stored. The contents stored in content DB 35 include a content in collaboration with the program broadcasted from broadcast station 2, a content connectable even after the broadcasting has completed, a content having no limitation to an reception area, and the like. Types of a concrete content include a still image, a moving image, sound, and the like. Further, these pieces of information are described in markup language, for example, XML (eXtensible Markup Language) or BML (Broadcast Markup Language). The use of such markup language realizes good compatibility with IP communication network 10.

Tuner IC DB 36 is a database in which at least device information is stored of receiving devices 5 used in information distribution system 1-1. Receiving devices 5 have different performances depending on manufacturers of concerned reception device 5 and types of a tuner IC embedded in reception device 5. Further, due to the effects of noise or the like when the tuner IC is embedded in concerned reception device 5, the reception sensitivity from the same broadcast station 2 varies per a product unit. Accordingly, tuner IC DB 36 stores therein a coefficient for each type of reception device 5 calculated based on various kinds of parameters which are used for calculating the comparable reception sensitivity and relate to a tuner IC, such as RSSI (Received Signal Strength Indication) or S/N ratio (SNR:Signal to Noise Ratio).

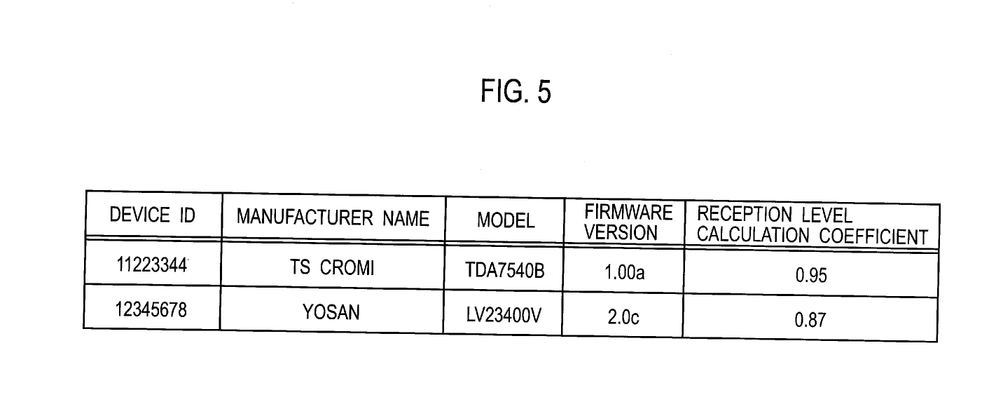

FIG. 5 is a view illustrating an example of data stored in tuner IC DB 36 shown in FIG. 3. As shown in FIG. 5, the data stored therein includes at least a “device ID”, a “manufacturer name”, a “model”, a “firmware version”, and a “reception level calculation coefficient”. In the “device ID”, identification information is stored with which reception device 5 can be uniquely identified in information distribution system 1-1. In the “manufacturer name”, a manufacturer name of reception device 5 is stored. In the “model”, model information determined by the manufacturer of reception device 5 is stored. In the “firmware version”, version information of a firmware of reception device 5 is stored. In the “reception level calculation coefficient”, a coefficient calculated based on characteristics of various kinds of parameters relating on each tuner IC is stored. Accordingly, in tuner IC DB 36, identification of a “device ID” makes it possible to uniquely determine a “manufacturer name”, a “model”, a “firmware version”, and a “reception level calculation coefficient” which are in association with the “device ID”.

(Broadcast Station Management Server) Broadcast station management server 4 has at least functions to authenticate reception device 5, to identify an area where concerned reception device 5 is installed, to enable a content provided from broadcast station portal server 3 corresponding to concerned broadcast station 2 to be outputted to only an area corresponding to a broadcast range of broadcast station 2, and the like. Broadcast station management server 4 is a server which performs centralized management in information distribution system 1-1. Further, broadcast station management server 4 may include information on broadcast station 2 which is not included in concerned information distribution system 1-1 (for example, a case where broadcast station portal server 3 corresponding to broadcast station 2 is present but is not registered in information distribution system 1-1 as concerned broadcast station portal server 3 corresponding to broadcast station 2, a case where broadcast station portal server 4 is not present originally, or the like). Broadcast station management server 4 corresponds to an example of an information distribution management device.

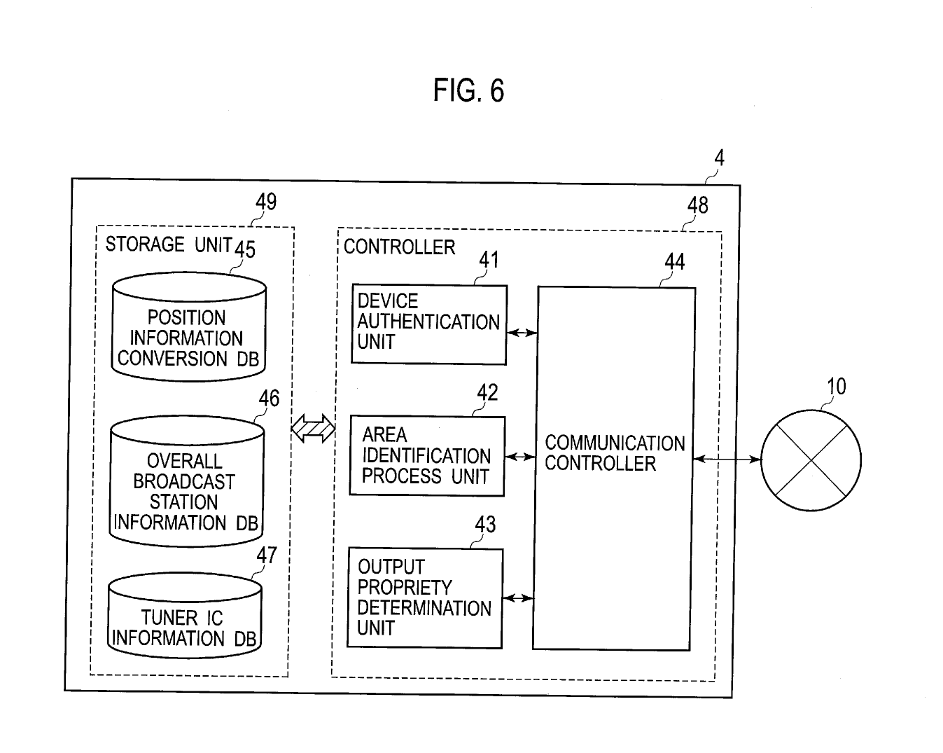

FIG. 6 is a block diagram illustrating an entire example of broadcast station management server 4 shown in FIG. 1. As shown in FIG. 6, broadcast station management server 4 is configured to include device authentication unit 41, area identification process unit 42, output propriety determination unit 43, communication controller 44, position information conversion DB 45, overall broadcast station information DB 46, and tuner IC information DB 47. Here, information processing implemented by functions of device authentication unit 41, area identification process unit 42, output propriety determination unit 43, and communication controller 44, which are described above, is implemented such that controller 48, controlling the entire broadcast station management server 4, executes the processing together with a hardware resource, which is not illustrated. Specifically, the information processing is implemented such that controller 48, which includes a CPU serving as the hardware resource (not illustrated) and the like, and a central processing device such as the CPU, reads out into a RAM (not illustrated) various kinds of programs stored in a storage part (not illustrated) such as a ROM, a hard disk drive, or a flash memory to execute the programs together with the RAM. Further, storage unit 49 stores therein position information conversion DB 45, overall broadcast station information DB 46, and tuner IC information DB 47 which are described above, and a storage device such as an HDD or a flash memory serves as storage unit 49.

Device authentication unit 41 authenticates whether reception device 5 is a correct device in information distribution system 1-1. In information distribution system 1-1, it is possible to perform device authentication of reception device 5 such that, for example, a common mechanism capable of issuing a one time device ID in advance, by a time stamp system similarly to One Time Password or Challenge & Response, is established in both sides of reception device 5 and concerned device authentication unit 41 to execute verification of the “device ID” between these devices. Further, device authentication unit 41 can store the abovementioned one time device ID (device ID) in tuner IC information DB 47.

Area identification process unit 42 identifies an area where reception device 5 is installed. Further, an area identification process performed by area identification process unit 42 is described later in detail. Output propriety determination unit 43 determines whether or not output of a content provided from broadcast station portal server 3 is allowed in reception device 5 (this operation will be referred to as an output propriety determination process). The output propriety determination process performed by output propriety determination unit 43 is described later in detail. Communication controller 44 is a communication interface for performing communication with an external device such as reception device 5 or broadcast station portal server 3 via IP communication network 10.

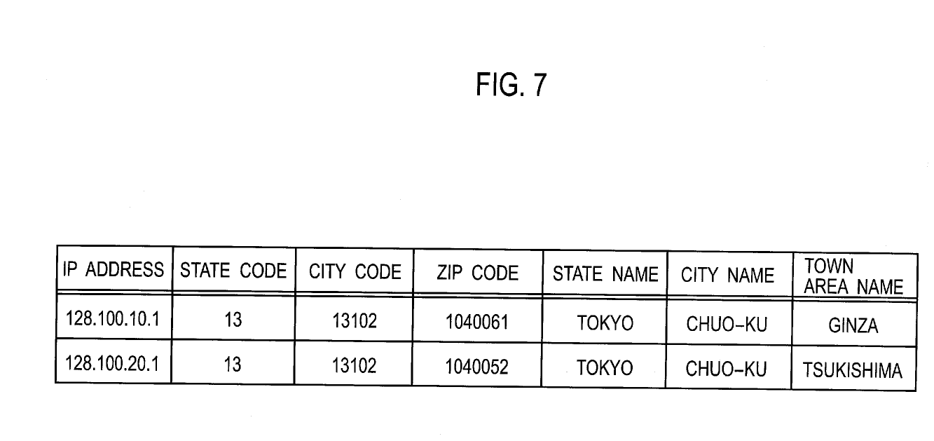

Position information conversion DB 45 is a database in which at least information capable of identifying position information from an IP address is stored. FIG. 7 is a view illustrating an example of information stored in position information conversion DB 45 shown in FIG. 6. As shown in FIG. 7, in position information conversion DB 45, at least an “IP address”, a “state code”, a “city code”, a “zip code”, a “state name”, a “city name”, a “town area name”, and the like are stored. In the “IP address”, a global IP address is stored. Further, as for a unit of the IP address to be stored, as shown in FIG. 7, in addition to a method of maintaining an IP address individually, a method of maintaining an IP address for every predetermined range (for example, per network address unit) may be employed. Position information conversion DB 45 corresponds to an example of a position information identification database.

Overall broadcast station information DB 46 is a database in which data relating on each broadcast station 2 included in information distribution system 1-1 is stored, and is a database, similar to broadcast station information DB 34 of broadcast station portal server 3, in which at least a radio frequency and an area section of broadcast station 2, a reception level condition in the area section, position information to be a viewing area of a broadcast content provided via IP communication network 10, and the like are stored Further, overall broadcast station information DB 46 is a collection of broadcast station information DB 34 of each broadcast station portal server 3, and therefore illustration thereof is omitted. Overall broadcast station information DB 46 corresponds to an example of a broadcast range identification database and an example of a reception sensitivity information database.

Tuner IC information DB 47 is a database, similar to tuner IC DB 36 of broadcast station portal server 3, in which at least device information on reception device 5 used in information distribution system 1-1 is stored. Further, tuner IC information DB 47 stores therein information similar to that stored in tuner IC DB 36 of broadcast station portal server 3, and therefore illustration thereof is omitted. Tuner IC information DB 47 corresponds to an example of reception sensitivity characteristics information database.

(Receiving device) Reception device 5 receives broadcast waves from broadcast station 2, and outputs a video and sound or outputs EPG information, of a received broadcast program. Further, when the reception status of broadcast waves sent from the antenna of broadcast station 2 is a predetermined level or higher, reception device 5 can output a content which is transmitted from broadcast station portal server 3 via IP communication network 10 and is identical with a content transmitted from broadcast station 2 in broadcast waves and/or a content relating to the content, or a different content other than the content. Further, reception device 5 corresponds to an example of an information reception device.

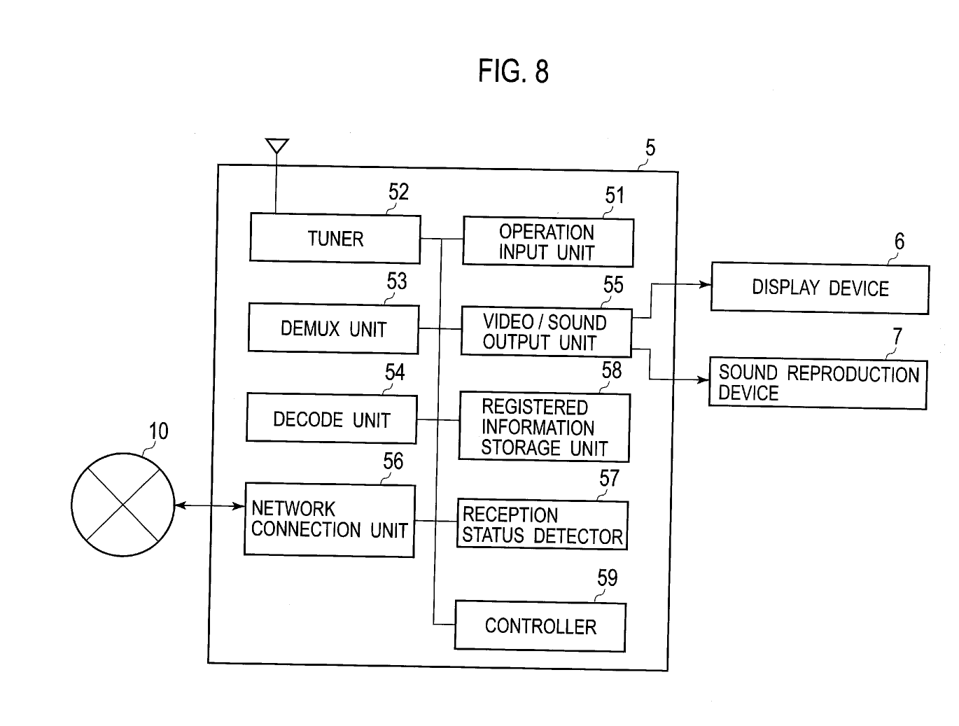

FIG. 8 is block diagram illustrating reception device 5 shown in FIG. 1. Reception device 5 is a stationary device which receives, for example, TV broadcasting or radio broadcasting from broadcast station 2, and is connectable to IP communication network 10. Further, reception device 5 outputs reception information from broadcast station 2, broadcast station management server 4, and broadcast station portal server 3 to display device 6 and sound reproduction device 7. Further, reception device 5 according to the embodiment is a device separated from display device 6 or sound reproduction device 7. However, reception device 5 is not limited thereto. Reception device 5 may be equipped together with display device 6, and sound reproduction device 7 in the same case, for example, a television set. Further, reception device 5 and display device 6 may be equipped in the same case, and only sound reproduction device 7 may be equipped in another case. That is, a device equipped with these three devices of reception device 5, display device 6, and sound reproduction device 7 is not especially limited. Further, reception device 5 may have a video-recording function and a sound-recording function.

As shown in FIG. 8, reception device 5 is configured to include operation input unit 51, tuner 52, DEMUX (DEMUltipleXer) unit 53, decode unit 54, video/sound output unit 55, network connection unit 56, reception status detector 57, registered information storage unit 58, and controller 59. Here, controller 59 is a central processing device which includes a CPU and the like and controls the entire reception device 5. The CPU reads out into a RAM, which is not illustrated, various kinds of programs stored in a storage part such as a ROM, a hard disk, or a flash memory, which is not illustrated, to execute these programs so that the functions of reception device 5 are implemented together with the respective units of operation input unit 51, tuner 52, DEMUX unit 53, decode unit 54, video/sound output unit 55, network connection unit 56, reception status detector 57, and registered information storage unit 58.

Operation input unit 51 accepts an operation input (selection instruction of a channel and the like) from a user, and reports the instruction by the user to controller 59. Operation input unit 51 includes, for example, a remote control or a touch panel, or can perform a sound input and the like. Operation of operation input unit 51 enables the user to perform an operation input to reception device 5. Further, the operation input to reception device 5 may be inputted to operation input unit 51 arranged in reception device 5 through a wireless signal (operation signal) such as an infrared ray. When a user inputs a selection instruction of a channel using operation input unit 51, a signal indicating the contents of this selection instruction is inputted to controller 59 via operation input unit 51 and a bus, which is not illustrated, and controller 59 transmits to tuner 52 a tuning instruction to the channel selected by the user via a bus, which is not illustrated.

In response to the tuning instruction from controller 59, tuner 52 receives broadcast waves from broadcast station 2 with the antenna, decodes the received RF (Radio Frequency) signal, performs an error correction process and the like, and outputs a TS signal including TS packets to DEMUX unit 53. Further, in FIG. 8, one tuner 52 for receiving terrestrial digital broadcasting is illustrated. However, when analog broadcasting, radio broadcasting (analog, digital), and BS broadcasting (analog, digital) are further received, tuners 52 therefor are arranged. Accordingly, two or more tuners 52 may be arranged.

DEMUX unit 53 performs a process of dividing a TS signal including TS packets from tuner 52 (that is, broadcast data obtained by multiplexing multiple streams such as videos and sound in MUX unit 24 of broadcast station 2 at the transmitting side), into stream data such as videos and sound and section type data such as SI/PSI. Further, each data divided by DEMUX unit 53 is supplied to decode unit 54.

Decode unit 54 decodes the broadcast content, the EPG information, and the information relating to the data broadcast which are supplied from DEMUX unit 53, and generates audio data, video data, and program data, respectively. Decode unit 54 supplies the audio data generated by decoding to sound reproduction device 7 described above. Sound reproduction device 7 performs a D/A conversion process on the supplied audio data, and outputs the audio data thus converted as a sound signal. Further, decode unit 54 supplies decoded video data and program data to video/sound output unit 55. The video data and the program data supplied to data video/sound output unit 55 are outputted to display device 6 and/or sound reproduction device 7. Further, decode unit 54 decodes data received from network connection unit 56, and supplies the data thus decoded to video/sound output unit 55. Decode unit 54 supplies these pieces of decoded data to a storage unit, which is not illustrated. Further, decode unit 54 may supply to the storage unit the data not as a decoded video signal or a decoded sound signal but as data signals without any change.

Video/sound output unit 55 stores the supplied program data in a RAM, which is not illustrated. Video/sound output unit 55 renders program data to generate EPG information. Further, video/sound output unit 55 generates a synthesized screen in which a screen based on the EPG information is synthesized on a screen based on the video data from decode unit 54, and sends the synthesized screen to display device 6. Display device 6 displays the synthesized screen. Further, in response to a storage instruction from controller 59, the decoded data by decode unit 54 is stored in a storage unit, which is not illustrated. Further, a method of outputting program data to video/sound output unit 55 is not limited to the method described above. Program data may be directly outputted to display device 6 without being stored in a RAM. Further, video/sound output unit 55 may output a screen of video data alone or a screen of EPG information alone to display device 6 separately, without generating a synthesized screen in which a screen based on EPG information is synthesized on a screen based on video data.

Network connection unit 56 is a communication interface which performs communication with broadcast station management server 4 via IP communication network 10. Network connection unit 56 receives data from broadcast station portal server 3 or broadcast station management server 4, and sends the data to decode unit 54.

Reception status detector 57 has a function to detect a reception status of broadcast waves sent from broadcast station 2 in response to a reception status detection instruction from controller 59. For example, reception status detector 57 includes a reception electric field strength signal generation circuit (not illustrated) capable of generating a reception electric field strength signal, and the like, such that a value obtained from the generation circuit is outputted to controller 59. As for the generation circuit, for example, a publicly known RSSI (Receive Signal Strength Indication) circuit is provided, a reception electric field strength signal can be obtained from the RSSI circuit. Further, any circuit may be employed as long a reception electric field strength is detected. The use of the reception electric field strength signal obtained from the reception electric field strength signal generation circuit described above makes it possible to detect a reception status of broadcast waves.

Registered information storage unit 58 stores therein registered information on a user who utilizes information distribution system 1-1 by use of concerned reception device 5 and device information on concerned reception device 5. Further, the registered information on a user here includes an IP address in association with a user allowed to utilize the information distribution system 1-1, a user ID of the user, a password in association with the user ID, an address, a zip code, and a telephone number of the user, and the like. Further, the device information on concerned reception device 5 includes device type information, device ID information, a serial number, and the like of concerned reception device 5.

Further, when scramble processing is applied to broadcast data which is superimposed on broadcast waves sent from broadcast station 2, reception device 5 may be provided with a descrambler unit (not illustrated) which releases the scramble. In that case, in response to the scramble release instruction from controller 59, the descrambler unit performs a process of releasing, to a normal signal, a TS signal including TS packets which is transmitted by being superimposed on the RF signal received in the tuner and subjected to the scramble processing. Further, the descrambler unit supplies the TS signal including TS packets of which the scramble processing is released to DEMUX unit 53.

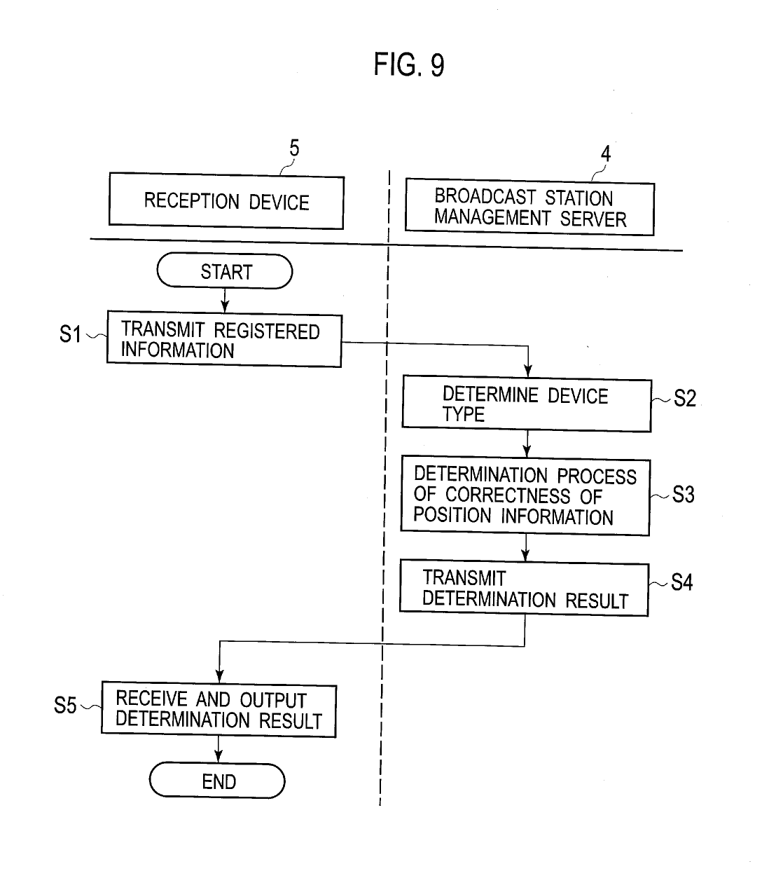

(Area Identification Process) Subsequently, an area identification process executed between broadcast station management server 4 and reception device 5 is described. FIG. 9 is a flowchart of the area identification process executed between broadcast station management server 4 and reception device 5 shown in FIG. 1.

START: Control unit 59 in reception device 5 starts the following process when an operation input signal for performing an area identification process is inputted from operation input unit 51 thereto.

Step S1: Control unit 59 transmits, to broadcast station management server 4, device information on concerned reception device 5 and registered information on a user which are stored in registered information storage unit 58. Specifically, controller 59 transmits, to broadcast station management server 4, device information on concerned reception device 5, IP address information allocated to concerned reception device 5, and zip code information of the user.

Step S2: Upon receiving information in Step S1 from reception device 5 through communication controller 44, controller 48 in broadcast station management server 4 determines a device type of concerned reception device 5. Specifically, controller 48 refers to tuner IC information DB 47, and identifies a device type of concerned reception device 5 as reception device 5 based on transmitted device information. When controller 48 can identify a device type based on the device information on reception device 5, controller 48 proceeds to a process in Step S3.

Step S3: Control unit 48 performs a process of checking correctness of position information transmitted from concerned reception device 5. Specifically, controller 48 refers to position information conversion DB 45, compares a position identified from transmitted IP address information with a position identified from transmitted zip code information, and checks for correctness of position information transmitted from concerned reception device 5 depending on whether “state names”, “city names”, and “town area names” in the positions match with each other, respectively. Further, in addition to the above-mentioned method of determining that the identified positions match with each other when the identified positions are compared and perfectly match with each other in terms of “state name”, “city name”, and “town area name,” other possible methods of comparing identified positions to determine matching include a determination method based on matching in terms of “state name” and “city name”, and a determination method based on matching in terms of “state name.” However, a method is preferably selected as appropriate by considering a status of accuracy of an area identified from the IP address and accuracy of an area identified from the zip code.

Step S4: As a result of comparison in Step S3, when controller 48 can check for correctness of the position information transmitted from reception device 5, controller 48 transmits to reception device 5 that the correctness has been checked. On the other hand, when controller 48 cannot check for correctness, controller 48 transmits to reception device 5 that the correctness has not been checked.

Step S5: Control unit 59 in reception device 5 receives a correctness check result via IP communication network 10 from broadcast station management server 4, displays a screen indicating the check result on display device 6, and ends the process (END).

In this manner, broadcast station management server 4 can check for correctness of area information of an area where reception device 5 is installed due to the determination process in Step S3 described above, by comparing position information obtained from IP address information transmitted from reception device 5 with position information obtained from zip code information.

(Output Propriety Determination Process)

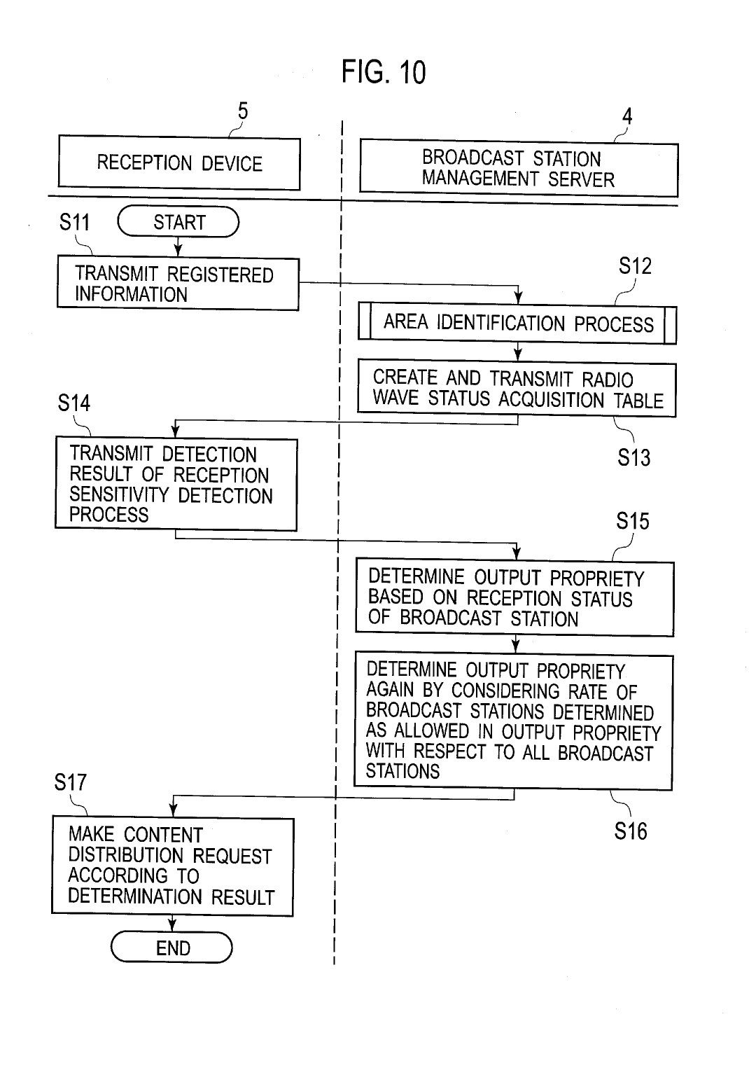

Subsequently, an output propriety determination process executed between broadcast station management server 4 and reception device 5 is described. FIG. 10 is a flowchart of the output propriety determination process executed between reception device 5 and broadcast station management server 4 shown in FIG. 1. Further, the following process may be continuously executed at the same time with the area identification process shown in FIG. 9, or may be executed independently after completion of the area identification process shown in FIG. 9.

START: Control unit 59 in reception device 5 starts the following process in response to an operation of operation input unit 51 by a user, when the user intends to know whether the broadcast content being received from broadcast station 2 can be received via IP communication network 10, or to switch the reception method for the broadcast content currently being viewed to IP communication network 10.

Step S11: Control unit 59 transmits, to broadcast station management server 4, device information on concerned reception device 5 and registered information on the user which are stored in registered information storage unit 58. Specifically, controller 59 transmits, to broadcast station management server 4, device information on concerned reception device 5, IP address information allocated to concerned reception device 5, and zip code information of the user.

Step S12: Upon receiving information in Step S11 from reception device 5 through communication controller 44, controller 48 in broadcast station management server 4 performs the area identification process in Step 3 shown in FIG. 9. Further, when the area identification process has been independently completed prior to Step S12, this process is not executed.

Step S13: Control unit 48 creates a radio wave status acquisition table indicating radio wave statuses receivable in an area identified in Step S12, and transmits the radio wave status acquisition table to reception device 5. Specifically, controller 48 refers to overall broadcast station information DB 46, lists all the “frequencies” in association with the area identified with the “zip code” to create a radio wave status acquisition table, and transmits the radio wave status acquisition table to reception device 5.

Step S14: Based on the radio wave status acquisition table transmitted from broadcast station management server 4, controller 59 in reception device 5 detects reception sensitivity of broadcast waves from each broadcast station, and transmits information on the radio wave status acquisition table including the detection result to broadcast station management server 4.

Step S15: Control unit 48 in broadcast station management server 4 determines whether each broadcast station 2 included in the radio wave status acquisition table transmitted in Step S14 is receivable or not based on whether the reception status of concerned broadcast station 2 reaches the “reception level” of concerned broadcast station 2 stored in overall broadcast station information DB 46, and determines whether output of a content in concerned reception device 5 is allowed based on the determination result of the reception performance. Specifically, controller 48 refers to overall broadcast station information DB 46 and tuner IC information DB 47, determines whether or not broadcast station 2 is receivable based on whether a value obtained by multiplying a value indicating the reception sensitivity in concerned broadcast station 2 by the reception level calculation coefficient of concerned reception device 5 reaches a value set as the reception level condition of concerned broadcast station 2, and determines whether output of a content provided from broadcast station portal server 3 corresponding to concerned broadcast station 2 is allowed based on this determination. That is, when the reception status of broadcast station 2 reaches a value set as the reception level condition of concerned broadcast station 2 and broadcast station 2 is determined as receivable, controller 48 determines that output of a content provided from broadcast station portal server 3 corresponding to concerned broadcast station 2 is allowed. On the other hand, when the reception status of broadcast station 2 does not reach the value, controller 48 determines that output of a content provided from broadcast station portal server 3 corresponding to concerned broadcast station 2 is not allowed. Control unit 48 executes this determination process with respect to all broadcast stations 2 included in the radio wave status acquisition table.

Step S16: In addition, when a rate (or number) of broadcast stations 2 for which it is determined that output of a content is allowed, with respect to all broadcast stations 2 determined in Step S15 is equal to or higher than a predetermined rate (for example, in a case where 50% or higher of broadcast stations 2 included in the radio wave status acquisition table are determined that output of a content is allowed, or the like), controller 48 determines that the output of a content is allowed for all broadcast stations 2 included in the radio wave status acquisition table, notifies reception device 5 of information on the radio wave status acquisition table including the determination result, and ends the process (END). On the other hand, when the rate of broadcast stations 2 for which it is determined that the output of a content is allowed with respect to all broadcast stations 2 determined in Step S15 is lower than a predetermined rate (for example, in a case where 30% of broadcast stations 2 included in the radio wave status acquisition table are determined that output of a content is allowed, or the like), controller 48 determines that output of a content is not allowed with respect to all broadcast stations 2 included in the radio wave status acquisition table, notifies reception device 5 of information on the radio wave status acquisition table including the determination result, and ends the process (END). Further, the predetermined rate described above may be uniformly set to the same rate with respect to all broadcast stations 2, or may be set by changing for each predetermined area.

Step S17: Control unit 59 in reception device 5 receives determination result information, and ends the process (END). After that, reception device 5 can execute a content distribution request to broadcast station portal server 3 corresponding to broadcast station 2 based on the determination result information notified from broadcast station management server 4.

Here, there may occur a situation where broadcast station 2 is determined as unreceivable because of a position where broadcast station 2 is located, a reception environment of a building where reception device 5 is installed, or the like, regardless that reception device 5 is located originally within the broadcast range of concerned broadcast station 2. Even in this situation, by performing the determination process in Step S16, broadcast station management server 4 can assume that concerned reception device 5 is present within the broadcast range if the determination results of a predetermined or higher rate of broadcast stations 2 included in the radio wave status acquisition table are receivable, and allow output of contents provided from broadcast station portal server 3 corresponding to concerned broadcast station 2 determined as unreceivable. On the other hand, there may occur another situation where, regardless that output of a content via IP communication network 10 is not allowed originally, a reception status of each broadcast station 2 is determined as receivable and output of a content is allowed because frequencies of broadcast stations 2 located in different areas match with each other accidentally. Even in this situation, broadcast station management server 4 can assume that concerned reception device 5 is not present within the broadcast range of concerned broadcast station 2 because reception statuses of other broadcast stations 2 included in the radio wave status acquisition table other than concerned broadcast station 2 become extremely worse, and determine that output of a content provided from broadcast station portal server 3 corresponding to concerned broadcast station 2 is not allowed. That is, even when a content distributed via a certain communication medium is provided via another communication medium, such broadcast station management server 4 and information distribution management method executed by broadcast station management server 4 allow the content to be distributed from broadcast station portal server 3 appropriately.

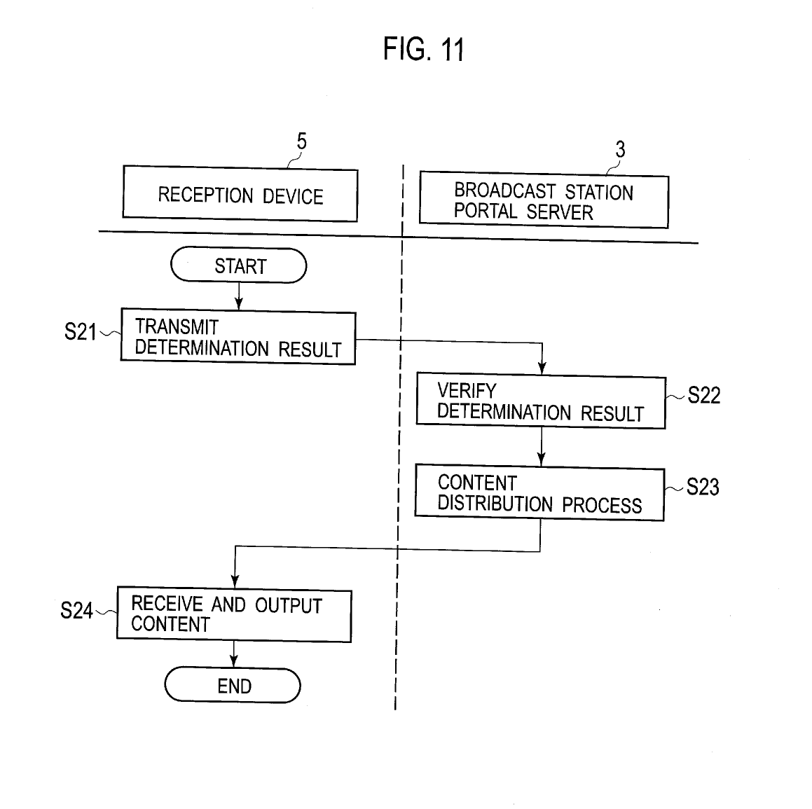

Subsequently, a content distribution process executed between reception device 5 and broadcast station portal server 3 is described. FIG. 11 is a flowchart of the content distribution process executed between reception device 5 and broadcast station portal server 3 shown in FIG. 1. Further, the process may be executed at the same time with the output propriety determination process shown in FIG. 10, or may be executed independently after the output propriety determination process.

START: Control unit 59 in reception device 5 starts the following process in response to an operation of operation input unit 51 by a user, when the user intends to know whether the broadcast content being received from broadcast station 2 can be received via IP communication network 10, or to switch the reception method for the broadcast content currently being viewed to IP communication network 10.

Step S21: Control unit 59 transmits determination result information on the radio wave status acquisition table received from broadcast station management server 4 by the output propriety determination process of a content shown in FIG. 10.

Step S22: Control unit 37 in broadcast station portal server 3 receives, from reception device 5, the determination result information on the radio wave status acquisition table in concerned reception device 5, verifies a content output propriety result from own broadcast station portal server 3, determines content distribution propriety. Further, a process may be executed such that prior to S22, determination result information on the radio wave status acquisition table in concerned reception device 5 is acquired from broadcast station management server 4 in advance, and is verified depending on whether the determination result information received from reception device 5 matches with the determination result information received from broadcast station management server 4.

Step S23: When a determination is made that content distribution is possible in Step S22, controller 37 distributes a content to reception device 5.

Step S24: Control unit 59 in reception device 5 receives the content distributed from broadcast station portal server 3, outputs the content to display device 6 and sound reproduction device 7, and ends the process (END).

Because after execution of the area identification process shown in FIG. 9 and the output propriety determination process shown in FIG. 10 with broadcast station management server 4, such reception device 5 executes the content distribution process shown in FIG. 11 with broadcast station portal server 3 based on the determination results thereof, even when a content distributed via a certain communication medium is provided via another communication medium, such reception device 5 allows the content to be distributed from broadcast station portal server 3 appropriately.

With information distribution system 1-1 described above, reception device 5 executes a process of identifying an area by a report of area information of a zip code, while broadcast station management server 4 determines whether concerned reception device 5 is present within a broadcast service area, and finally determines whether or not output of a content provided from broadcast station portal server 3 is allowed by considering not only a reception sensitivity status of individual broadcast station 2 but also reception sensitivity statuses of multiple broadcast stations 2 receivable in the area. With such information distribution system 1-1, broadcast station management server 4, an information distribution management method executed by concerned broadcast station management server 4, reception device 5, and a reception method executed by concerned reception device 5, there is originally no need to request to the Internet service provider for disclosure of personal information, and only a report of area information such as a zip code is required. Thus, even when a content distributed via a certain communication medium is provided via another communication medium, the content is allowed to be appropriately transmitted/received without excessive use of personal information.

As in the foregoing, although information distribution system 1-1 has been explained as the first embodiment, the invention is not limited thereto, and various modifications and changes are possible without departing from the spirit of the inventions. For example, with the output propriety determination method according to the first embodiment, when equal to or higher than a predetermined rate of broadcast stations 2 included in radio wave status acquisition table is determined as receivable, a determination is made such that output of contents provided from broadcast station portal servers 3 corresponding to all broadcast stations 2 included in radio wave status acquisition table is allowed. Alternatively, when a predetermined or higher rate of specific broadcast stations 2 included in radio wave status acquisition table are determined as receivable, output of contents provided from broadcast station portal servers 3 corresponding to all broadcast stations 2 included in radio wave status acquisition table may be allowed. Specifically, for example, when a rate of receivable stations for AM stations included in radio wave status acquisition table is equal to or higher than a predetermined rate, or a rate of receivable stations for FM stations included in radio wave status acquisition table is equal to or higher than a predetermined rate, output of contents provided from broadcast station portal servers 3 corresponding to all broadcast stations 2 included in radio wave status acquisition table may be allowed.

In addition, when specific broadcast station 2 out of broadcast stations 2 included in radio wave status acquisition table is determined as receivable, without considering reception statuses of other broadcast stations 2, output of contents provided from broadcast station portal servers 3 corresponding to all broadcast stations 2 included in radio wave status acquisition table may be allowed. Specifically, for example, when broadcast station 2 (for example, a community broadcast station) in a limited area having an extremely narrower broadcast range compared with those of other broadcast stations 2 is determined as receivable, output of contents provided from broadcast station portal servers 3 corresponding to all broadcast stations 2 included in radio wave status acquisition table may be allowed.

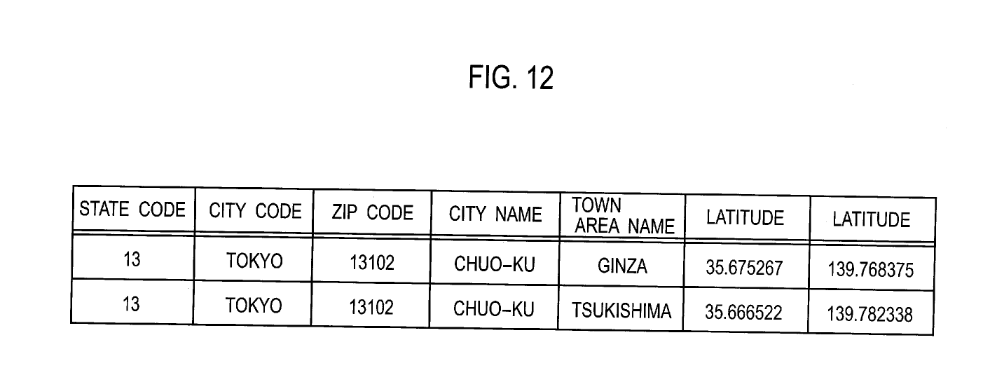

Further, although receiving devices 5 in the first embodiment and modification examples thereof described above are assumed to be used as a stationary type, a reception device 5 of a moving body type may be employed. In that case, because area identification is impossible using a zip code or the like, reception device 5 needs to be provided with a GPS function. Further, in broadcast station management server 4, a latitude and longitude conversion table, as shown in FIG. 12, with which a position can be identified from latitude and longitude information is added to position information conversion DB 45. Further, reception device 5 of a moving body type acquires latitude and longitude information indicating current position using a GPS function, and transmits the latitude and longitude information thus acquired with IP address information on reception device 5 to broadcast station management server 4. Meanwhile, broadcast station management server 4 refers to position information conversion DB 45 to which the latitude and longitude conversion table is added, and compares an area identified from the latitude and longitude information transmitted from reception device 5 of a moving body type with an area identified from the IP address information to identify an area where reception device 5 of a moving body type is located. Further, processes (output propriety determination process, content distribution process) after that area identification process in reception device 5 of a moving body type are the same as those in the embodiment described above, and therefore explanation thereof is omitted.

Further, although the output propriety determination process as shown in FIG. 10 is exemplified in the first embodiment and modification examples thereof described above, alternatively, the following output propriety determination process may be employed. For example, at the time when identifying an area where reception device 5 is installed from device information on reception device 5, IP address information allocated to concerned reception device 5, and zip code information on a user, if broadcast station 2 being set as a service area (a flag is 0) in the area section of the area is present, broadcast station management server 4 may determine at that time that output of a content from broadcast station portal server 3 corresponding to concerned broadcast station 2 is allowed, and if broadcast station 2 being set as a fringe area (flag is 1) is present, broadcast station management server 4 may create a radio wave status acquisition table in which only concerned broadcast stations 2 being set as a fringe area are included, and transmit the radio wave status acquisition table to reception device 5. Employing such creation method for a radio wave status acquisition table makes it possible to reduce an amount of data to be transmitted, and to save reception device 5 from the trouble of detecting again the reception sensitivity of broadcast station 2 known in advance as being in a service area.

Further, although reception sensitivity is detected with reception electric field strength as a method of detecting reception sensitivity of broadcast station 2 by reception device 5 in the first embodiment and modification examples thereof described above, alternatively, a reception error rate detection circuit (not illustrated) capable of detecting a reception error rate may be provided in reception device 5 to cause the reception error rate detection circuit to generate a detection signal when a reception error rate exceeds a predetermined reference value, and the presence or absence of the detection signal may be transmitted to broadcast station management server 4. Further, when a detection method of detecting reception sensitivity of broadcast station 2 with a reception error rate is employed, standard reception error rates within the broadcast range of broadcast stations 2 are stored in overall broadcast station information DB 46 of broadcast station management server 4 in advance, and a reception error rate coefficient for multiplication for every reception device 5 is stored in tuner IC information DB 47 of broadcast station management server 4 in advance. It is preferable to perform output propriety determination based on these kinds of information.

Further, although a client-server type network system in which a content is downloaded from broadcast station portal server 3 is employed in the first embodiment and modification examples thereof described above, a P2P (Peer To Peer) type network system may be employed. In this case, a content distribution request to broadcast station portal server 3 is broadcast transmitted as a search query to broadcast station portal server 3 or broadcast station management server 4 included in information distribution system 1-1, and information indicating the reception status is further transmitted. Only when the information indicating the reception status satisfies a reference value, information on a peer (computer) holding the content is transmitted, and the content may be downloaded from the peer.

Further, all or a part of the functions provided with the respective devices explained in the first embodiment and modification examples thereof described above are configured by a program and this program is installed into an information processing device (computer) so that the above-mentioned functions provided with the respective devices may be implemented. In particular, all or a part of the functions provided with broadcast station management server 4 explained in the first embodiment and modification examples thereof described above are configured by a program and this program is installed into an information processing device (computer) so that the abovementioned functions provided with broadcast station management server 4 may be implemented. Further, although it is possible to install an information distribution management program into a computer directly from a medium in which this information distribution management program is recorded in an executable state, this information distribution management program may be installed into a distanced computer via a network. With such information distribution management program, without excessive use of personal information, even when a content distributed via a certain communication medium is provided via another communication medium, the content is allowed to be appropriately transmitted/received.

### Second Embodiment

Subsequently, information distribution system 1-2 according to a second embodiment is described. An entire example of information distribution system 1-2 according to the second embodiment is the same as the configuration example (FIG. 1) shown in the first embodiment, and therefore illustration and explanation thereof are omitted. Further, information distribution system 1-2 according to the second embodiment is different from information distribution system 1-1 according to the first embodiment in that content output propriety determination made by both of broadcast station management server 4 and reception device 5 is made mainly by reception device 5.

(Broadcast Station) Broadcast station 2 sends a broadcast program content as stream data according to a broadcast schedule. Further, broadcast station 2 can send data broadcast and EPG (Electronic Program Guide) information by being superimposed on broadcast waves, respectively. An entire configuration of broadcast station 2 is the same as the configuration example (FIG. 2) shown in the first embodiment, and therefore illustration and explanation thereof are omitted. Note that, broadcast station 2 corresponds to an example of a radio station.

(Broadcast Station Portal Server) Broadcast station portal server 3 provides a content corresponding to broadcast station 2 to reception device 5 via IP communication network 10. The content includes a broadcast content of broadcast station 2 (a content corresponded to a so-called simultaneous broadcasting by broadcast station 2), an associated content related to the content such as a still image, sound, and a moving image, a unique content produced uniquely independent from the broadcast content (for example, a website, text information, still image information, and moving image information which are provided from broadcast station portal server 3), and the like. An entire configuration of broadcast station portal server 3 is the same as the configuration example (FIG. 3) shown in the first embodiment, and therefore illustration and explanation thereof are omitted. Note that, broadcast station portal server 3 corresponds to an example of an information distribution device.

(Broadcast Station Management Server) Broadcast station management server 4 has at least functions to authenticate reception device 5, to identify an area where concerned reception device 5 is installed, to enable a content provided from broadcast station portal server 3 corresponding to concerned broadcast station 2 to be outputted to only an area corresponding to a broadcast range of broadcast station 2, and the like. Broadcast station management server 4 is a server which performs centralized management in information distribution system 1-2. Further, broadcast station management server 4 may include information on broadcast station 2 which is not included in concerned information distribution system 1-2 (for example, a case where broadcast station portal server 3 corresponding to broadcast station 2 is present but is not registered in information distribution system 1-2 as concerned broadcast station portal server 3 corresponding to broadcast station 2, a case where broadcast station portal server 4 is not present originally, or the like). Broadcast station management server 4 corresponds to an example of the information distribution management device.

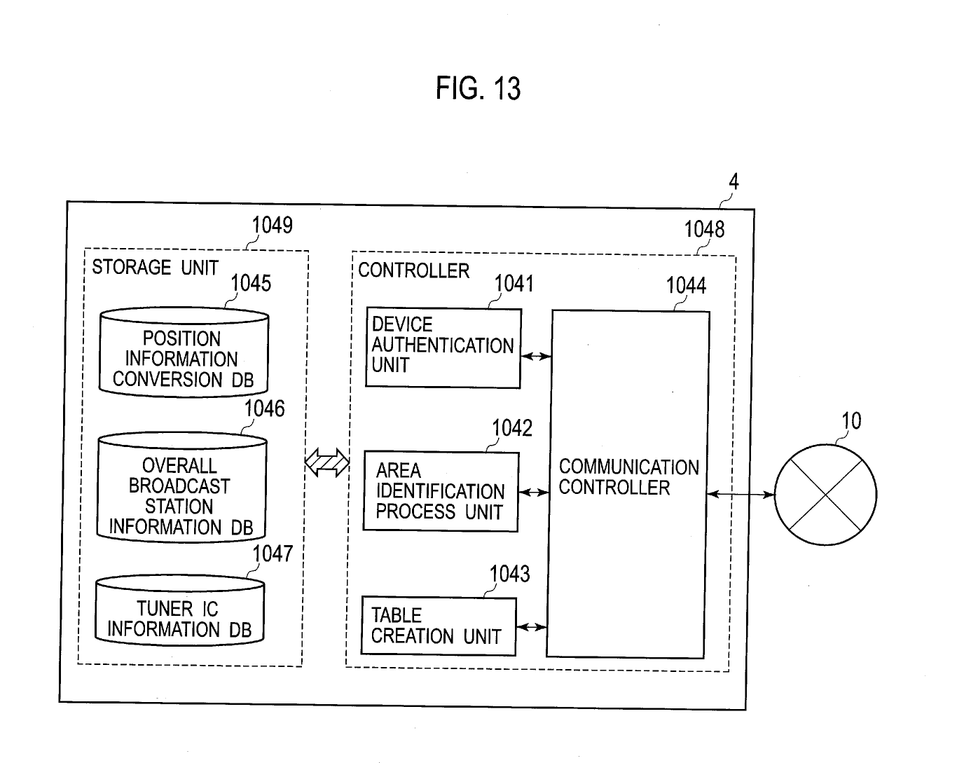

FIG. 13 is a block diagram illustrating an entire example of broadcast station management server 4 shown in FIG. 1. As shown in FIG. 13, broadcast station management server 4 is configured to include device authentication unit 1041, area identification process unit 1042, table creation unit 1043, communication controller 1044, position information conversion DB 1045, overall broadcast station information DB 1046, and tuner IC information DB 1047. Here, information processing implemented by functions of device authentication unit 1041, area identification process unit 1042, table creation unit 1043, and communication controller 1044, which are described above, is implemented such that controller 1048 controlling entire broadcast station management server 4 executes the processing together with a hardware resource, which is not illustrated. Specifically, the information processing is implemented such that controller 1048 includes a CPU serving as the hardware resource, which is not illustrated, and the like, and the CPU reads out into a RAM, which is not illustrated, various kinds of programs stored in a storage part, which is not illustrated, such as a ROM, a hard disk drive, or a flash memory to execute the programs together with the RAM. Further, storage unit 1049 stores therein position information conversion DB 1045, overall broadcast station information DB 1046, tuner IC information DB 1047, which are described above, and a storage device such as an HDD or a flash memory serves as storage unit 1049.

Device authentication unit 1041 authenticates whether reception device 5 is a correct device in information distribution system 1-2. In information distribution system 1-2, it is possible to perform device authentication of reception device 5 such that, for example, a common mechanism capable of issuing an one time device ID in advance, by a time stamp system similarly to One Time Password or Challenge & Response, is established in both sides of reception device 5 and concerned device authentication unit 1041 to execute verification of the “device ID” between these devices. Further, device authentication unit 1041 can store the abovementioned one time device ID (device ID) in tuner IC information DB 1047 for every reception device 5.

Area identification process unit 1042 identifies an area where reception device 5 is installed. Further, an area identification process performed by area identification process unit 1042 is described later in detail. Table creation unit 1043 creates, based on position information transmitted from reception device 5, a list of broadcast stations 2 receivable in area where the reception device is installed. Communication controller 1044 is an communication interface for performing communication with an external device such as reception device 5 or an broadcast station portal server 4 via IP communication network 10.

Position information conversion DB 1045 is a database in which at least information capable of identifying position information from an IP address is stored. FIG. 7 is a view illustrating an example of information stored in position information conversion DB 1045 shown in FIG. 13. As shown in FIG. 7, in position information conversion DB 1045, at least an “IP address”, a “state code”, a “city code”, a “zip code”, a “state name”, a “city name”, a “town area name”, and the like are stored. In the “IP address”, a global IP address is stored. Further, as for a unit of the IP address to be stored, as shown in FIG. 7, in addition to a method of maintaining an IP address individually, a method of maintaining an IP address for each predetermined range (for example, per network address unit) may be employed. Position information conversion DB 1045 corresponds to an example of a position information identification database.

Overall broadcast station information DB 1046 is a database in which data relating on each broadcast station 2 included in information distribution system 1-2 is stored, and is a database, similarly to broadcast station information DB 34 of broadcast station portal server 3, in which at least a radio frequency and an area section of broadcast station 2, a reception level condition in the area section, position information to be a viewing area of a broadcast content provided via IP communication network 10, and the like are stored Further, overall broadcast station information DB 1046 is a collection of broadcast station information DB 34 of each broadcast station portal server 3, and therefore illustration thereof is omitted. Overall broadcast station information DB 1046 corresponds to an example a broadcast range identification database and an example of a reception sensitivity information database.

Tuner IC information DB 1047 is a database, similarly to tuner IC DB 36 of broadcast station portal server 3, in which at least device information on reception device 5 used in information distribution system 1-1 is stored. Further, tuner IC information DB 1047 stores therein information similarly to that stored in tuner IC DB 36 of broadcast station portal server 3, and therefore illustration thereof is omitted. Tuner IC information DB 1047 corresponds to an example of reception sensitivity characteristics information database.

(Receiving device) Reception device 5 receives broadcast waves from broadcast station 2, and outputs a video and sound or outputs EPG information, of a received broadcast program. Further, when the reception status of broadcast waves sent from the antenna of broadcast station 2 is a predetermined level or higher, reception device 5 can output a content which is transmitted from broadcast station portal server 3 via IP communication network 10 and is identical with a content transmitted from broadcast station 2 in broadcast waves and/or a content relating on the content, or a different content other than the content. Note that, reception device 5 corresponds to an example of an information reception device.

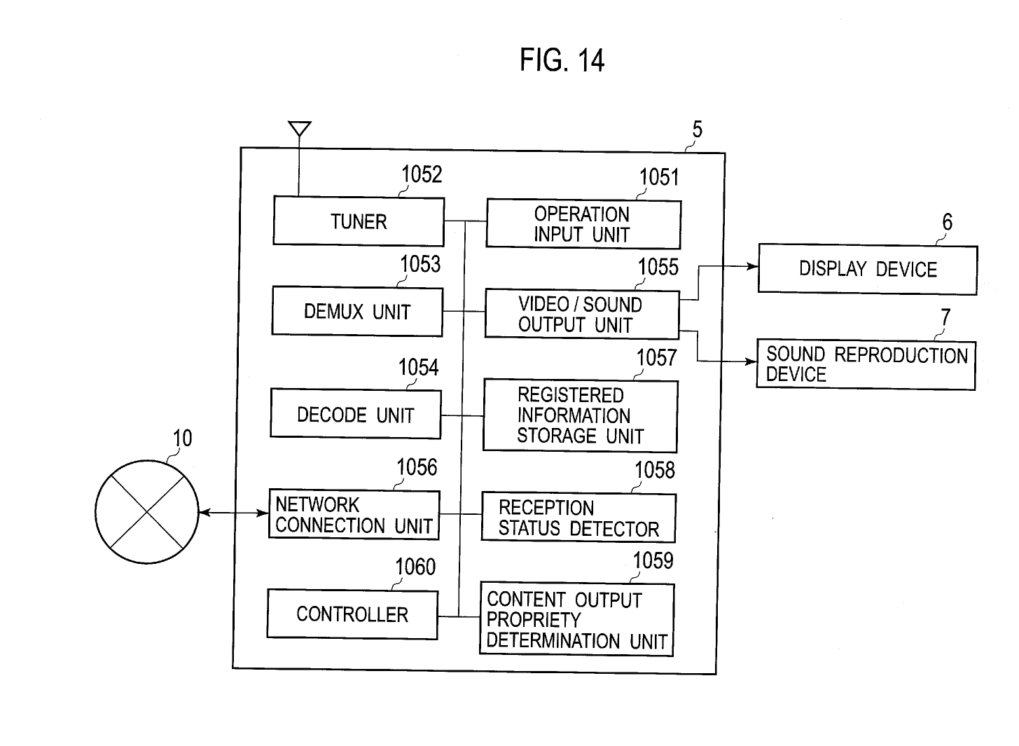

FIG. 14 is block diagram illustrating reception device 5 shown in FIG. 1. Reception device 5 receives, for example, TV broadcasting or radio broadcasting from broadcast station 2, and is a stationary device connectable to IP communication network 10. Further, reception device 5 outputs reception information from broadcast station 2, broadcast station management server 4, and broadcast station portal server 3 to display device 6 and sound reproduction device 7. Further, reception device 5 according to the embodiment is a device separated from display device 6 or sound reproduction device 107. However, reception device 5 is not limited thereto, reception device 5 may be equipped together with display device 106, and sound reproduction device 7 in the same case, for example, a television set. Further, reception device 5 and display device 6 may be equipped in the same case, and only sound reproduction device 7 may be equipped in another case. That is, a device equipped with these three devices of reception device 5, display device 6, and sound reproduction device 7 is not especially limited. Further, reception device 5 may have a video-recording function and a sound-recording function.

As shown in FIG. 14, reception device 5 is configured to include operation input unit 1051, tuner 1052, DEMUX (DEMUltipleXer) unit 1053, decode unit 1054, video/sound output unit 1055, network connection unit 1056, reception status detector 1057, registered information storage unit 1058, content output propriety determination unit 1059, and controller 1060. Here, controller 1060 is a central processing device which includes a CPU and the like and controls the entire reception device 5. The CPU reads out into a RAM, which is not illustrated, various kinds of programs stored in a storage part such as a ROM, a hard disk, or a flash memory, which is not illustrated, to execute these programs so that the functions of reception device 5 are implemented together with the respective units of operation input unit 1051, tuner 1052, DEMUX unit 1053, decode unit 1054, video/sound output unit 1055, network connection unit 1056, reception status detector 1057, registered information storage unit 1058, and content output propriety determination unit 1059.

Operation input unit 1051 accepts an operation input (selection instruction of a channel and the like) from a user, and reports the instruction by the user to controller 1060. Operation input unit 1051 includes, for example, a remote control or a touch panel, or can be receive a sound input and the like. Operation of operation input unit 1051 enables the user to perform an operation input to reception device 5. Further, the operation input to reception device 5 may be inputted to operation input unit 1051 arranged in reception device 5 through a wireless signal (operation signal) such as an infrared ray. When a user inputs a selection instruction of a channel using operation input unit 1051, a signal indicating the contents of this selection instruction is inputted to controller 1060 via operation input unit 51 and a bus, which is not illustrated, and controller 1060 transmits to tuner 1052 an tuning instruction to the channel selected by the user via a bus, which is not illustrated.

In response to the tuning instruction from controller 1060, tuner 1052 receives broadcast waves from broadcast station 2 with the antenna, decodes the received RF (Radio Frequency) signal, performs an error correction process and the like, and outputs a TS signal including TS packets to DEMUX unit 1053. Further, in FIG. 14, one tuner 1052 for receiving terrestrial digital broadcasting is illustrated. However, when analog broadcasting, radio broadcasting (analog, digital), and BS broadcasting (analog, digital) are further received, tuners 1052 therefor are arranged. Accordingly, two or more tuners 1052 may be arranged.

DEMUX unit 1053 performs a process of dividing a TS signal including TS packets from tuner 1052 (that is, broadcast data obtained by multiplexing multiple streams such as videos and sound in MUX unit 24 of broadcast station 2 at the transmitting side, into stream data such as videos and sound and section type data such as SI/PSI. Further, each data divided by DEMUX unit 1053 is supplied to decode unit 1054.

Decode unit 1054 decodes the broadcast content, the EPG information, and the data broadcast which are supplied from DEMUX unit 53, and generates audio data, video data, and program data, respectively. Decode unit 54 supplies the audio data generated by decoding to sound reproduction device 107 described above. Sound reproduction device 107 performs a D/A conversion process on the supplied audio data, and outputs the supplied audio data thus converted as a sound signal. Further, decode unit 1054 supplies decoded video data and program data to video/sound output unit 1055. The video data and the program data supplied to data video/sound output unit 1055 are outputted to display device 6 and/or sound reproduction device 7. Further, decode unit 1054 decodes data received from network connection unit 1056, and supplies the data thus decoded to video/sound output unit 1055. Decode unit 1054 supplies these pieces of decoded data to a storage unit, which is not illustrated. Further, decode unit 1054 may supply to the storage unit the data not as a decoded video signal or a decoded sound signal but as data signals without any change.

Video/sound output unit 1055 stores the supplied program data in a RAM, which is not illustrated. Video/sound output unit 1055 renders program data to generate EPG information. Further, video/sound output unit 1055 generates a synthesized screen in which a screen based on the EPG information is synthesized on a screen based on the video data from decode unit 1054, and sends the synthesized screen to display device 6. Display device 6 displays the synthesized screen. Further, the decoded data by decode unit 1054 in response to a storage instruction from controller 1060 is stored in a storage unit, which is not illustrated. Note that, a method of outputting program data to video/sound output unit 1055 is not limited to the method described above. Program data may be directly outputted to display device 6 without being stored in a RAM. Further, video/sound output unit 1055 may separately output a screen of video data alone or a screen of EPG information alone to display device 6, without generating a synthesized screen in which a screen based on EPG information is synthesized on a screen based on video data.

Network connection unit 1056 is a communication interface which performs communication with broadcast station management server 4 via IP communication network 10. Network connection unit 1056 receives data from broadcast station portal server 3 or broadcast station management server 4, and sends the data to decode unit 1054.

Reception status detector 1057 has a function to detect a reception status of broadcast waves sent from broadcast station 2 in response to a reception status detection instruction from controller 1060. For example, reception status detector 1057 includes a reception electric field strength signal generation circuit (not illustrated) capable of generating a reception electric field strength signal, and the like, such that a value obtained from the generation circuit is outputted to controller 1060. As for the generation circuit, for example, a publicly known RSSI (Receive Signal Strength Indication) circuit is provided, a reception electric field strength signal can be obtained from the RSSI circuit. Further, any circuit may be employed as long a reception electric field strength is detected. The use of the reception electric field strength signal obtained from the reception electric field strength signal generation circuit described above makes it possible to detect a reception status of broadcast waves.

Registered information storage unit 1058 stores therein registered information on a user who utilizes information distribution system 1-2 by the use of concerned reception device 5, device information on concerned reception device 5, and determination result information on a radio wave status acquisition table stored in content output propriety determination unit 1059 describe later. Further, the registered information on a user here includes an IP address in association with a user allowed to use the information distribution system 1-2, a user ID of the user, a password in association with the user ID, an address, a zip code, and telephone number of the user, and the like. Further, the device information on concerned reception device 5 includes device type information, device ID information, a serial number, and the like of concerned reception device 5.

Content output propriety determination unit 1059 determines whether or not output of a content provided from broadcast station portal server 3 corresponding to broadcast station 2 is allowed in an area where reception device 5 is installed. Further, an output propriety determination process performed by content output propriety determination unit 1059 is described later in detail.

Further, when scramble processing is applied to broadcast data which is superimposed on broadcast waves sent from broadcast station 2, reception device 5 may be provided with a descrambler unit (not illustrated) which releases the scramble. In the case, in response to the instruction from controller 1060, the descrambler unit performs a process of releasing, to a normal signal, a TS signal including TS packets transmitted by being superimposed on the received RF signal by the tuner and subjected to the scramble processing. Further, the descrambler unit supplies the TS signal including TS packets of which the scramble processing is released to DEMUX unit 1053.

(Area Identification Process) An area identification process executed between broadcast station management server 4 and reception device 5 in the second embodiment is the same as the process in FIG. 9 shown in the first embodiment, and therefore illustration and explanation thereof are omitted.

(Output Propriety Determination Process)

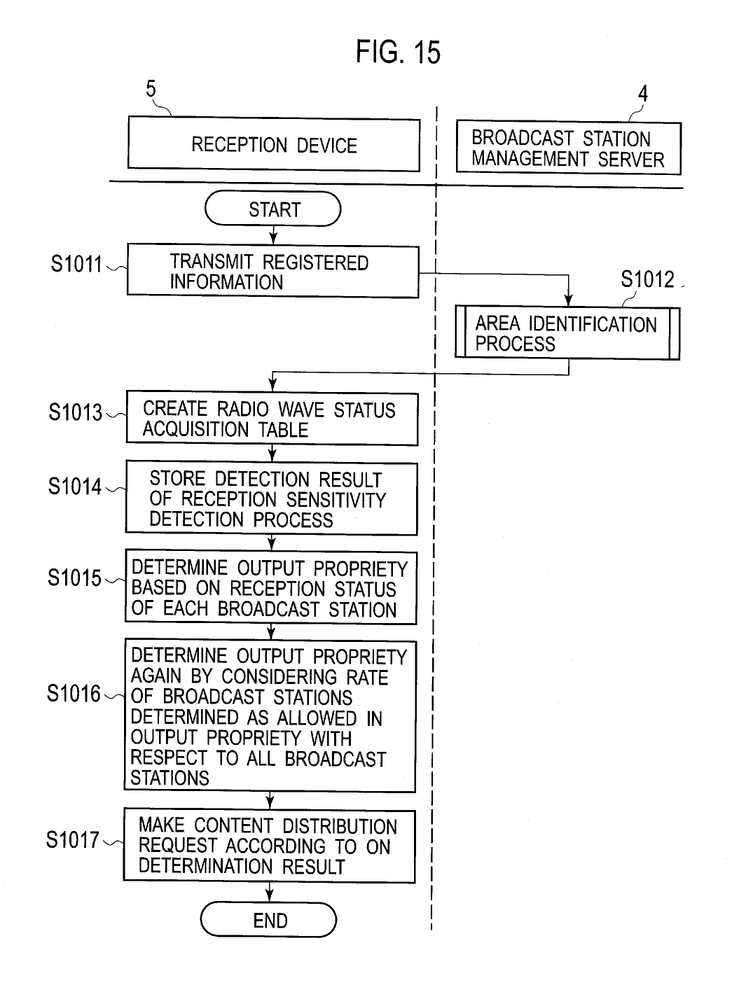

Subsequently, an output propriety determination process executed between broadcast station management server 4 and reception device 5 is described. FIG. 15 is a flowchart of the output propriety determination process executed between reception device 5 and broadcast station management server 4 shown in FIG. 1. Further, the following process may be continuously executed at the same time with the area identification process, or may be executed independently after completion of the area identification process shown in FIG. 9.

START: Control unit 1060 in reception device 5 starts the following process in response to an operation of operation input unit 1051 by a user, when the user intends to know whether the broadcast content being received from broadcast station 2 can be received via IP communication network 10, or to switch the reception method for the broadcast content currently being viewed to IP communication network 10.

Step S1011: Control unit 1060 transmits, to broadcast station management server 4, device information on concerned reception device 5 and registered information on the user which are stored in registered information storage unit 1058. Specifically, controller 1060 transmits, to broadcast station management server 4, device information on concerned reception device 5, IP address information allocated to concerned reception device 5, and zip code information of the user.

Step S1012: Upon receiving information in Step S1011 from reception device 5 through communication controller 1044, controller 1048 in broadcast station management server 4 performs the area identification process in Step 3 shown in FIG. 9.

Step S1013: Control unit 1048 creates a radio wave status acquisition table indicating radio wave statuses receivable in an area identified in Step S1012, and transmits the radio wave status acquisition table to reception device 5. Specifically, controller 1048 refers to overall broadcast station information DB 1046, lists all the “frequencies” in association with the area identified with the “zip code” to create a radio wave status acquisition table, and transmits the radio wave status acquisition table to reception device 5.

Step S1014: Based on the radio wave status acquisition table transmitted from broadcast station management server 4, controller 1060 in reception device 5 detects reception sensitivity of broadcast waves from each broadcast station.

Step S1015: Control unit 1060 determines whether each broadcast station 2 included in the radio wave status acquisition table transmitted in Step S1014 is receivable or not based on whether the reception status of concerned broadcast station 2 reaches the “reception level” of concerned broadcast station 2 stored in overall broadcast station information DB 1046, and determines whether or not output of a content in concerned reception device 5 is allowed based on the determination result of the reception performance. Specifically, controller 1060 refers to overall broadcast station information DB 1046 and tuner IC information DB 1047 in broadcast station management server 4 via IP communication network 10, determines whether or not concerned broadcast station 2 is receivable based on whether a value obtained by multiplying a value indicating the reception sensitivity in concerned broadcast station 2 by the reception level calculation coefficient of concerned reception device 5 reaches a value set as the reception level condition of concerned broadcast station 2, and determines whether or not output of a content provided from broadcast station portal server 3 corresponding to concerned broadcast station 2 is allowed based on this determination. That is, when the reception status of broadcast station 2 reaches a value set as the reception level condition of concerned broadcast station 2 and broadcast station 2 is determined as receivable, controller 1060 determines that output of a content provided from broadcast station portal server 3 corresponding to concerned broadcast station 2 is allowed. On the other hand, when the reception status of broadcast station 2 does not reach the value, controller 1060 determines that output of a content provided from broadcast station portal server 3 corresponding to concerned broadcast station 2 is not allowed. Control unit 1060 executes this determination process with respect to all broadcast stations 2 included in the radio wave status acquisition table.

Step S1016: In addition, when a rate of broadcast stations 2 which are determined that output of a content is allowed among all broadcast stations 2 determined in Step S1015 is equal to or higher than a predetermined rate (for example, in a case where 50% or higher of broadcast stations 2 included in the radio wave status acquisition table are determined that output of a content is allowed, or the like), controller 1060 determines that output of a content is allowed with respect to all broadcast stations 2 included in the radio wave status acquisition table. On the other hand, when a rate of broadcast stations 2 which are determined that output of a content is allowed among all broadcast stations 2 determined in Step S1015 is lower than a predetermined rate (for example, in a case where 30% of broadcast stations 2 included in the radio wave status acquisition table are determined that output of a content is allowed, or the like), controller 1060 determines that output of a content is not allowed with respect to all broadcast stations 2 included in the radio wave status acquisition table. Further, the predetermined rate described above may be uniformly set to the same rate with respect to all broadcast stations 2, or may be set by changing for each predetermined area.

Step S1017: Control unit 1060 stores determination result information in registered information storage unit 1058, and ends the process (END). After that, reception device 5 can execute a content distribution request to broadcast station portal server 3 corresponding to broadcast station 2 based on the determination result information stored in registered information storage unit 1058.

Here, there may occur a situation where broadcast station 2 is determined as unreceivable because of a position where broadcast station 2 is located, a reception environment of a building where reception device 5 is installed, for example, or the like, regardless that reception device 5 is located originally within the broadcast range. Even in this situation, by performing the determination process in Step S1016, reception device 5 can assume that concerned reception device 5 is present within the broadcast range if the determination results of a predetermined or higher rate of broadcast stations 2 included in the radio wave status acquisition table are receivable, and allow output of a content provided from broadcast station portal server 3 corresponding to concerned broadcast station 2 determined as unreceivable. On the other hand, there may occur another situation where a reception status of each broadcast station 2 is determined as receivable and output of a content is allowed, because frequencies of broadcast stations 2 located in different areas match with each other incidentally, regardless that output of a content via IP communication network 10 is not allowed originally. Even in this case, reception device 5 can assume that concerned reception device 5 is not present within the broadcast range of concerned broadcast station 2 because reception statuses of other broadcast stations 2 included in the radio wave status acquisition table other than concerned broadcast station 2 become extremely worse, and determine that output of a content provided from broadcast station portal server 3 corresponding to concerned broadcast station 2 is not allowed. That is, even when a content distributed via a certain communication medium is provided via another communication medium, reception device 5 and information distribution management method executed by reception device 5 allow the content to be distributed from broadcast station portal server 3 appropriately.

A content distribution process executed between reception device 5 and broadcast station portal server 3 in the second embodiment is the same as the content distribution process (FIG. 11) in the first embodiment, and therefore illustration and explanation thereof are omitted.

With information distribution system 1-2 described above, reception device 5 identifies an area only from a report of area information of a zip code, determines by itself whether reception device 5 is present within the broadcast service area, and finally determines whether or not output of a content provided from broadcast station portal server 3 is allowed, by considering not only a reception sensitivity status of single broadcast station 2 but also reception sensitivity statuses of multiple broadcast stations 2 receivable in the area. Such information distribution system 1-2, reception device 5, and an information reception method executed by reception device 5 do not request from the Internet service provider for disclosure of personal information is not required originally, but requires only a report of area information such as a zip code. Thus, even when a content distributed via a certain communication medium is provided via another communication medium, the content is allowed to be appropriately transmitted/received without excessive use of personal information.

As in the foregoing, although information distribution system 1-2 has been explained as the second embodiment, the invention is not limited thereto, and various modifications and changes are possible without departing from the spirit of the inventions. For example, with the output propriety determination method according to the second embodiment, when a predetermined or higher rate of broadcast stations 2 included in radio wave status acquisition table are determined as receivable, it is determined that output of contents provided from broadcast station portal servers 3 corresponding to all broadcast stations 2 included in radio wave status acquisition table is allowed. Alternatively, when a predetermined or higher rate of specific broadcast stations 2 included in radio wave status acquisition table is determined as receivable, output of contents provided from broadcast station portal servers 3 corresponding to all broadcast stations 2 included in radio wave status acquisition table may be allowed. Specifically, for example, when a rate of receivable stations for AM stations included in radio wave status acquisition table is equal to or higher than a predetermined rate, or a rate of receivable stations for FM stations included in radio wave status acquisition table is equal to or higher than a predetermined rate, output of contents provided from broadcast station portal servers 3 corresponding to all broadcast stations 2 included in radio wave status acquisition table may be allowed.

In addition, when specific broadcast station 2 out of broadcast stations 2 included in radio wave status acquisition table is determined as receivable, without considering reception statuses of other broadcast stations 2, output of contents provided from broadcast station portal servers 3 corresponding to all broadcast stations 2 included in radio wave status acquisition table may be allowed. Specifically, for example, when broadcast station 2 (for example, a community broadcast station) in a limited area having an extremely narrower broadcast range compared with that of other broadcast stations 2 is determined as receivable, output of contents provided from broadcast station portal servers 3 corresponding to all broadcast stations 2 included in radio wave status acquisition table may be allowed.

Further, although receiving devices 5 in the second embodiment and modification examples thereof described above are assumed to be used as a stationary type, a reception device 5 of a moving body type may be employed. In that case, because area identification is impossible using a zip code or the like, reception device 5 needs to be provided with a GPS function. Further, in broadcast station management server 4, a latitude and longitude conversion table, as shown in FIG. 12, with which a position can be identified from latitude and longitude information is added to position information conversion DB 1045. Further, reception device 5 of a moving body type acquires latitude and longitude information indicating current position using a GPS function, and transmits the latitude and longitude information thus acquired with IP address information on reception device 5 to broadcast station management server 4. Meanwhile, broadcast station management server 4 refers to position information conversion DB 1045 to which the latitude and longitude conversion table is added, and compares an area identified from the latitude and longitude information transmitted from reception device 5 of a moving body type with an area identified from the IP address information to identify an area where reception device 5 of a moving body type is located. Further, processes (output propriety determination process, content distribution process) after that area identification process in reception device 5 of a moving body type are the same as those in the embodiment described above, and therefore explanation thereof is omitted.

Further, although the output propriety determination process as shown in FIG. 15 is exemplified in the second embodiment and modification examples thereof described above, alternatively, the following output propriety determination process may be employed. For example, at the time when identifying an area where reception device 5 is installed from device information on own device, IP address information allocated to concerned reception device 5, and zip code information on a user, if broadcast station 2 being set as a service area (a flag is 0) in the area section of the area is present, reception device 5 may determine at that time that output a content from broadcast station portal server 3 corresponding to concerned broadcast station 2 is allowed, and if broadcast station 2 being set as a fringe area (flag is 1) is present, reception device 5 may create a radio wave status acquisition table in which only concerned broadcast stations 2 being set as a fringe area are included, and store the radio wave status acquisition table in registered information storage unit 1058. Employing such creation method for a radio wave status acquisition table makes it possible to reduce an amount of data of the radio wave status acquisition table, and to save the trouble of detecting again reception sensitivity of broadcast station 2 known in advance as being in a service area.

Further, although reception sensitivity is detected with reception electric field strength as a method of detecting reception sensitivity of broadcast station 2 by reception device 5 in the second embodiment and modification examples thereof described above, alternatively, a reception error rate detection circuit (not illustrated) capable of detecting a reception error rate may be provided in reception device 5 to cause the reception error rate detection circuit to generate a detection signal when a reception error rate exceeds a predetermined reference value, and the presence or absence of the detection signal may be transmitted to registered information storage unit 1058. Further, when a detection method of detecting reception sensitivity of broadcast station 2 with a reception error rate is employed, standard reception error rates within the broadcast range of broadcast stations 2 are stored in overall broadcast station information DB 1046 of broadcast station management server 4 in advance, and a reception error rate coefficient for multiplication for every reception device 5 is stored in tuner IC information DB 1047 of broadcast station management server 4 in advance. After reception device 5 performs a process of acquiring these kinds of information, it is preferable that reception device 5 make output propriety determination.

Further, although position information conversion DB 1045, overall broadcast station information DB 1046, and tuner IC information DB 1047 are arranged in the side of broadcast station management server 4 and reception device 5 acquires necessary information in the second embodiment and modification examples thereof described above, all or a part of position information conversion DB 1045, overall broadcast station information DB 1046, and tuner IC information DB 1047 may be arranged in the side of reception device 5, and the area identification process and the output propriety determination process for information present in own device may be executed in reception device 5 without using IP communication network 10.

Further, although a client-server type network system in which a content is downloaded from broadcast station portal server 3 is employed in the second embodiment and modification examples thereof described above, a P2P (Peer To Peer) type network system may be employed. In this case, a content distribution request to broadcast station portal server 3 is broadcast transmitted as a search query to broadcast station portal server 3 or broadcast station management server 4 included in information distribution system 1-2, and information indicating the reception status is further transmitted. Only when the information indicating the reception status satisfies a reference value, information on a peer (computer) holding the content is transmitted, and the content may be downloaded from the peer.

Further, all or a part of the functions provided with the respective devices explained in the second embodiment and modification examples thereof described above are configured by a program and this program is installed into an information processing device (computer) so that the above-mentioned functions provided with the respective devices may be implemented. In particular, all or a part of the functions provided with reception device 5 explained in the second embodiment and modification examples thereof described above are configured by a program and this program is installed into an information processing device (computer) so that the abovementioned functions provided with reception device 5 may be implemented. Further, although it is possible to install an information distribution management program into a computer directly from a medium in which this information distribution management program is recorded in an executable state, this information distribution management program may be installed into a remote computer via a network. With such information distribution management program, even when a content distributed via a certain communication medium is provided via another communication medium, the content is allowed to be appropriately transmitted/received without excessive use of personal information.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An information distribution system, comprising:
An information reception device configured to receive information sent via radio waves from a radio station;
an information distribution device configured to distribute information to the information reception device; and
an information distribution management device configured to manage information distribution,
wherein the information distribution device is further configured to distribute a content via a communication medium different from the radio waves within a content delivery range within which the radio station sends the content via the radio waves,
wherein the information distribution management device comprises:
a content output propriety determination unit configured to determine whether output of the content is allowed in the information reception device based on reception statuses of radio waves from a plurality of radio stations received by the information reception device and position information on the information reception device;
a communication controller configured to transmit a determination result by the content output propriety determination unit to the information reception device; and
a table creation unit configured to create a radio wave status acquisition table for acquiring the reception statuses of the radio waves from the radio stations, with the table created being based on the position information on the information reception device,
wherein the content output propriety determination unit is further configured to transmit the radio wave status acquisition table to the information reception device, and to allow output of contents distributed from the information distribution devices corresponding to all the radio stations included in the table
when a determination is made, based on the reception statuses of radio waves from some radio stations out of the reception statuses of the radio waves from the radio stations acquired based on the radio wave status acquisition table and transmitted from the information reception device, that the some radio stations are receivable,
wherein the information reception device comprises:
a communication unit configured to communicate with the information distribution device capable of distributing a content within the content delivery range of the radio station by using the communication medium different from the radio waves;
a content output propriety determination information output unit configured to send its own position information to the information distribution management device, the information distribution management device being further configured
to determine whether output of the content, distributed from the information distribution device to the information reception device via the communication unit, is allowed in the information reception device to receive the radio wave status acquisition table created based on the position information by the information distribution management device and used for acquiring the reception statuses of the radio waves from the radio stations,
to acquire the reception statuses of the radio waves from the radio stations included in the radio wave status acquisition table, and
to transmit the acquired radio wave statuses to the information distribution management device; and
a content output controller configured to determine whether output of the content distributed from the information distribution device is allowed based on the content output propriety determination result transmitted from the information distribution management device.

2. An information distribution management device capable of determining whether an output of a content is allowed, comprising:
a content output propriety determination unit configured to determine whether an output of a content provided by an information distribution device is allowed in an information reception device based on reception statuses in the information reception device of radio waves from a plurality of radio stations and position information on the information reception device, wherein the information reception device is configured to receive a content that a radio station sends via radio waves, and the information distribution device is configured to distribute the content within a content delivery range of the radio station via a communication medium other than the radio waves;
a communication controller configured to transmit a determination result by the content output propriety determination unit to the information reception device; and
a table creation unit configured to create a radio wave status acquisition table used for acquiring the reception statuses of the radio waves from the radio stations based on the position information on the information reception device,
wherein the content output propriety determination unit is configured
to send the information reception device the radio wave status acquisition table,
to determine whether output of contents from the information distribution devices corresponding to the some radio stations is allowed in the information reception device based on the reception statuses of the radio waves from some radio stations out of the reception statuses of the radio waves from the radio stations acquired based on the radio wave status acquisition table and transmitted from the information reception device, and, when it is determined that the output of the contents from the information distribution devices corresponding to the some radio stations is allowed,
to allow output of the contents distributed from the information distribution devices corresponding to all the radio stations included in the table.

3. The information distribution management device of claim 2, wherein
the some radio stations comprise a predetermined number of radio stations from all the radio stations included in the radio wave status acquisition table, and
the content output propriety determination unit is configured to allow output of the contents distributed from the information distribution devices corresponding to all the radio stations included in the table when it is determined that the predetermined number of radio stations are receivable based on the reception statuses of radio waves from the predetermined number of radio stations.

4. The information distribution management device of claim 2, wherein
the some radio stations are specific radio stations out of the radio stations included in the radio wave status acquisition table, and
the content output propriety determination unit allows output of the contents distributed from the information distribution devices corresponding to all the radio stations included in the table when it is determined that the specific radio stations are receivable based on the reception statuses of radio waves from the specific radio stations.

5. The information distribution management device of claim 2, further comprising:
a position information identification database with which the position information of the information reception device is identifiable; and
a broadcast range identification database with which a broadcast range of the radio station is identifiable,
wherein the content output propriety determination unit is configured to use the position information identification database to identify the position information on the information reception device, and to determine whether an output of a content provided from the information distribution device corresponding to the radio station is allowed, depending on whether an identified position of the information reception device is included in the broadcast range of the radio station stored in the broadcast range identification database.

6. The information distribution management device of claim 2, further comprising a reception sensitivity information database with which reception sensitivity information in the broadcast range of the radio station is identifiable,
wherein the content output propriety determination unit determines whether output of a content provided from the information distribution device corresponding to the radio station is allowed, based on information indicating the reception status of the radio waves from the radio station in the information reception device and the reception sensitivity information in the broadcast range of the radio station stored in the reception sensitivity information database.

7. The information distribution management device of claim 6, further comprising a reception sensitivity characteristics information database in which reception sensitivity characteristics information on the information reception device for each of the radio stations is stored,
wherein the content output propriety determination unit determines whether output of a content provided from the information distribution device corresponding to a radio station is allowed, based on information indicating the reception status of the radio waves from the radio station in the information reception device and the reception sensitivity characteristics information on the radio station in the information reception device stored in the reception sensitivity characteristics information database.

8. An information distribution management method comprising:
determining as a determination result whether output of a content distributed to an information reception device from an information distribution device is allowed in the information reception device based on a communication status of a first communication medium in the information reception device and position information on the information reception device, the information reception device being capable of receiving the content that a radio station sends via the first communication medium, and the information distribution device being capable of distributing the content within a content delivery range of the first communication medium via a second communication medium different from the first communication;
transmitting the determination result to the information reception device;
creating a reception status acquisition table including radio stations associated with the position information on the information reception device;
transmitting the created reception status acquisition table to the information reception device;
receiving, from the information reception device, reception statuses of associated radio stations via the first communication medium acquired based on the reception status acquisition table;
determining whether an output of contents from the information distribution devices corresponding to some of the associated radio stations is allowed in the information reception device, based on the reception statuses of the some of the associated radio stations; and
allowing output of the contents distributed from the information distribution devices corresponding to all the radio stations included in the reception status acquisition table when the step of determining shows that the output of the contents from the information distribution devices corresponding to the some radio stations is allowed.

9. A computer program product comprising program instructions recorded on a computer readable medium, wherein upon execution on a computer, said program instructions decide whether to output contents to a receiving device, the program instructions comprising:
determining as a determination result whether output of a content distributed to an information reception device from an information distribution device is allowed in the information reception device based on a communication status of a first communication medium in the information reception device and position information on the information reception device, wherein the information reception device is configured to receive the content that a radio station sends via the first communication medium, and the information distribution device is configured to distribute the content within a content delivery range of the first communication medium via a second communication medium different from the first communication;
transmitting the determination result to the information reception device;
creating a reception status acquisition table including radio stations associated with the position information on the information reception device;
transmitting the created reception status acquisition table to the information reception device;
receiving, from the information reception device, reception statuses from the associated radio stations via the first communication medium acquired based on the reception status acquisition table;
determining whether or not output of contents from the information distribution devices corresponding to some of the associated radio stations is allowed in the information reception device, based on the reception statuses of the some radio stations; and
when determining that the output of the contents from the information distribution devices corresponding to the some radio stations is allowed in the information reception device, allowing output of the contents distributed from the information distribution devices corresponding to all the radio stations included in the reception status acquisition table.
